(19) United States
(12) Patent Application Publication
(10) Pub. No.: US 2017/0316477 A1
(43) Pub. Date: Nov. 2, 2017

(54) SYSTEM AND METHOD FOR IDENTIFYING, VERIFYING AND COMMUNICATING ABOUT OEM PRODUCTS USING UNIQUE IDENTIFIERS

(71) Applicant: Chachi PRASAD, Los Angeles, CA (US)

(72) Inventor: Chachi PRASAD, Los Angeles, CA (US)

(21) Appl. No.: 15/616,013

(22) Filed: Jun. 7, 2017

Related U.S. Application Data
(63) Continuation of application No. 14/699,452, filed on Apr. 29, 2015.
Application No. 14/699,452 is a continuation-in-part of application No. 14/025,767, filed on Sep. 12, 2013, now abandoned.
(60) Provisional application No. 61/826,491, filed on May 23, 2013.
(60) Provisional application No. 61/700,063, filed on Sep. 12, 2012.

(51) Int. Cl. G06Q 30/06; G06Q 50/00; G06Q 30/00

(52) U.S. Cl. CPC G06Q 30/0601; G06Q 30/0185; G06Q 50/01

(57) ABSTRACT

The present invention is directed to a mobile software application developed for a smart phone or mobile device, such as an iPhone, iPad, Android, or Blackberry personal digital assistant, equipped with a camera, image sensor, RFID detector, or NFC sensor, that enables a user to identify, verify and synchronize information to verify information related to the brand and style of an OEM product and optionally the present status of whether an OEM product is genuine, subject to recall or stolen, and further allows the user to communicate and share information about the product using social media and networking sites on the Internet.

### CROSS REFERENCE TO RELATED PATENT APPLICATIONS

The present application is a Continuation-in-Part application to U.S. Utility patent application Ser. No. 14/025,767, filed Sep. 12, 2013, entitled “SYSTEM AND METHOD FOR VERIFYING AND COMMUNICATING ABOUT OEM PRODUCTS”, which claims priority to U.S. Provisional Patent Application No. 61/826,491, filed May 23, 2013 and U.S. Provisional Patent Application No. 61/700,063, filed Sep. 12, 2012, the contents of which are incorporated by reference herein and which are a basis for a claim of priority.

### BACKGROUND OF THE INVENTION

### Field of the Invention

The invention relates generally to the field of mobile applications for handheld devices, and systems and methods for identifying, verifying and communicating about OEM products using a combination of unique identifiers, mobile device apps, social media and networking websites on the Internet.

### Background Information

Original equipment manufacturers (OEM) manufacture products or components of products, which they sell to authorized dealers and/or retailers who then sell the products to end consumers under the OEM's brand. Some OEMs also sell their goods and products directly to end consumers in the market. The OEM's brand, which includes trademarks, service marks, logos, trade names, and tag lines, is a valuable intangible asset that indicates the OEM as the source of particular goods or services. Indeed, companies invest significant time and money in developing, marketing and protecting their brands.

Despite OEM manufacturers' efforts to protect their brands, counterfeiting is a prevalent problem. This is true especially in the area of consumer goods and luxury items, including among other things, clothing, shoes, luggage, handbags, perfumes, electronic equipment, watches, jewelry, toys, art, DVDs, and computer software. Imitation, black and grey market goods, or “knockoffs” are often manufactured, distributed, and sold in direct competition with genuine OEM products.

Often, customers have difficulty distinguishing the imitation or “knockoff” products from the genuine/authentic OEM products. Companies lose billions of dollars a year because of counterfeiting when consumers are diverted to purchasing “knockoffs” instead of genuine goods. Furthermore, the brands and goodwill associated with branded products suffer when consumers believe they are purchasing a high-quality genuine item, but receive an inferior-quality “knockoff” product.

An additional problem OEM manufacturers face is brand recognition. OEM manufacturers' often spend a large amount of time and money to create a brand or style but in certain fields such as the apparel industry it can be very difficult to distinguish the Brand, style or model of an observed product of interest versus that of a competitor. In certain areas of fashion there are few easily identifiable distinctions between the brands or models or styles of goods. Thus, it is important to make it easier for the consumer to first identify products, brands or models of goods they like so they can make the selection they were hoping for especially when the product is first seen outside of the retail store context which includes the full tag and ability to further inspect.

Hence, there is a need in the marketplace for sophisticated and user-friendly technology that allows the proper identification and sharing of information among consumers of products of interest and optionally a detection of counterfeit and “knockoff” products, which may allows one consumer to alert the OEM manufacturer, as well as other consumers about whether one has purchased a genuine good or an imitation or “knockoff.” In recent years, various methods and systems have been developed to detect and track counterfeit goods.

For example, U.S. Pat. No. 5,895,073, entitled “Anti-counterfeiting System”, describes one such anti-counterfeiting system that marks, identifies, and tracks goods using a control computer, a host computer, a marking system, and field reader system that can be linked via data transmission links. The goods are marked with encoding symbols, which can be subsequently inspected with a field reader to determine whether they are genuine. U.S. Pat. No. 6,226,619, entitled Method and System for Preventing Counterfeiting of High Price Wholesale and Retail Items, discloses a method and system for preventing counterfeiting by using an interrogatable, which includes indicia visible by the purchaser for comparison with a secret, non-duplicable number or other information stored in the tag which designates authenticity.

U.S. Pat. No. 7,222,791, entitled “Counterfeit Detection Method”, describes a method including the steps of electronically reading a label on a particular item in a store, transmitting an item identification code (such as a bar code) encoded in the read label to an authentication unit, receiving an indication from the authentication unit as to whether the identification code is registered to the store, and if the indication is positive, generating a certificate of authenticity for the item. U.S. Publication No. 20040172537, entitled “System and Method for Tracking and Authenticating Items Through an Internet Web Site”, describes a method for tracking an item using an internet web site for a user to verify that the item is genuine, which includes the steps of entering a code to obtain secure access to the web site, selecting the item from a list on the website, determining whether the code is authentic, allowing modification of the tracking data if the code is determined to be authentic, and sending an alert to a fraud potential if the code is determined to be not authentic. The system uses a taggant such as a TechMark™ magnetic threat or fluorescent taggant along with a second unique identifier such as a serial number or a bar code or various other identifiers.

U.S. Publication No. 2011021172, entitled “Authentication of ‘Source’ for brands.” describes a brand source authentication system in real time. The system detects brand sources using camera-enabled imagers and hard wiring, as well as camera-enabled smart phones and internet communications, wherein the detection devices are equipped to read encoded 2-D, Data Matrix type symbology included in the products.

A synchronization system for product identification for consumers to properly identify their product of interest and share information with other consumers and the option to further detect or verify counterfeit or stolen merchandise that is capable of use by an individual consumer to identify prospective purchases in detail in a synchronistic way which enables a user to scan a product for a unique identifier with a personal mobile device such as a cell-phone and synchronize communications with OEM's regarding the status and/or validity of the item has not been previously identified.

### SUMMARY OF THE INVENTION

The embodiments of the present invention first relate to consumer identification and sharing of product knowledge through the use of Unique Product Identifiers for consumer goods, which may be scanned or read with a mobile app to provide full disclosure of information of interest in regards to the good the consumer is interested in. Some of the information relevant is the source of the good, the style of the good, the model, as well as where to purchase and pricing information as well as promotional opportunities related to the consumer good.

Some embodiments of the present invention rely on a combination of technologies such as mobile device applications or computer software to detect, identify, verify and or disseminate information related to a good, based on the information received from a form a Unique Identifier source which may include RFID with the barcode chips of both iPhone and android can utilize it for example and connecting, detecting and communicating via one or a combination thereof: 1. Bluetooth; 2. BLE the Bluetooth low energy; 3. Wi-Fi; 4. RFID; 5. Barcode; 6. New sensor devices; 7. Satellites (GPS); 8. NFC; 9. Beacons; and other wireless technologies capable of storing and transferring specific information.

Further embodiments include the ability for a users clothes and products to transmit signals to the users device, beacons, or to other individuals utilizing RFID, BLE, GPS, NFC or other chip type and information transmission technology. Further embodiments may include chips that enable the user to listen to music, watch videos, movies or ads either from iCloud or the chip itself. Additional embodiments include the ability to program the chip to turn on lights, appliances, turn an automobile on and off, open doors, set alarms, internal thermostat and the like. Yet additional embodiments include the ability to carry information on the chip and the ability of the chip to produce a hologram image from the device.

Yet further embodiments include a UID or Digital Fingerprint which can be utilized as serial number for products wherein the serial number can perform any of the following functions:

1. Invite New Customers—when a user purchases a product with the serial number and scans it, they can invite new users. The new users will be prompted to utilize the serial number as a means to shop. When the new user utilizes the number the person who sent them the number will be incentivized.

2. A merchant or OEM or other user may use the serial number to track information related to individual and groups of customers and how many are coming through the serial number.

3. A merchant or OEM or other user may use the serial number to track sales of a certain product including model, style and/or size.

4. A merchant or OEM or other user may use the serial number system to view more information regarding the product details including material used, where and when made.

5. A merchant or OEM or other user may use the serial number system to track the route in which the product was shipped.

6. A merchant or OEM or other user may use the serial number system to track sales and habits of customers.

7. A merchant or OEM or other user may use the serial number system to send updates and push notifications of deals and events.

8. A merchant or OEM or other user may use the serial number system to connect to other users that are nearby, that have the same tastes, that have similar products and/or are generally part of the system.

9. The embodied serial number or UID system allows users to approve a connection to another user.

10. The embodied serial number or UID system allows users to control certain personal space based on the product at hand. For example, walking in with a certain clothing on will allow you to: a. Control lights and appliances in the home; b. Start or enter an automobile: and/or c. Broadcast to others what the users location is.

11. The embodied serial number or UID system allows people to share experiences, information and social interactions.

12. The system allows brands/companies to show a video, lookbook and other valuable company information they desire to share with their users.

13. The system tracks how many users have signed up or purchased products with a specific serial number or code so the system can incentivize the original user of the serial number or code. Incentives can be in the form of free merchandise, coupons, credits.

Individual embodiments of the system may utilize various combinations of technologies including: Bluetooth, RFID or NFC; Bluetooth, RFID or NFC with GPS; Bluetooth. RFID or NFC, with GPS and/or Wi-Fi; Bluetooth, RFID or NFC, with a 9-Axis sensor; Bluetooth, RFID and WiFi with a 9-Axis Sensor, NFC OR RFID WITH BARCODE, BLE with NFC or RFID.

Additional embodiments related to the sensor or detector mechanism itself include the ability to include the option of having a battery power source, or a solar power source or a kinetic movement based power generator system and/or other power processing mechanisms known in the art.

The sensors may include housings for protecting the sensors and chips from the elements and may be in various different shapes. The size of the modules/housings are typically from approximately 5-10 mm×2.5-10 mm and only a few mm thick. Generally the housing shapes may be straight or have a 20 to 30 degree curve at the backside. Additionally the housing shapes may have a textured and or minimal adhesive on the back side for non-slippage during application onto the product. The housings are generally waterproof, pressure proof and heat resistant. As shown in the figures the housings with the sensors are generally placed strategically in product seams and other discrete areas so the sensor is hidden and not easily accessible. Additionally, the sensor may include the ability to be voice activated and may or may not have LED lights.

The embodiments of the present invention utilize a UID or (digital finger print for each product), this UID can be utilized as a invitation code or shopping code. When a new shopper or user utilizes a friends UID, who has invited him to shop, the friend will get incentives in the form of product or points or cash.

Additional embodiments include alerting the user or member when their code is being used to shop. This creates a way for brands to utilize incentive rather than relying on Google ranking or ad words. For example if a user invites 10 friends and 5 shop with the users UID or serial number, then the user could receive credit for the purchases and an incentive such as free product for every 5 purchases utilizing your code. Additional embodiments include a way for users to connect to others who are owners of similar products.

After the appropriate identification of the consumer good desired it may also be useful to use the embodied SYNCA type application to verify status of the good desired.

The fraudulent product detection systems and methods described in the prior art generally enable a consumer to detect if a particular good or service is genuine, but they do not allow easy, user-friendly communication and dissemination of information about the genuine or imitation article to interested parties, such as manufacturers, existing and potential consumers, and product critics. Nor do they allow the consumer to share his or her experiences about the particular good or service with other interested parties that may use the information to make purchasing, marketing, and use decisions. Accordingly, the present invention includes embodiments directed to a user-friendly system and method for identifying and verifying the genuineness of consumer goods and for communicating about said goods on social media and networking websites on the Internet using a hand-held smart phone or other mobile device, equipped with application software (such as an embodied synchronization APP an example of which is a Synca™ APP), hard wiring, and Imaging and/or sensing capabilities, which substantially obviate one or more problems due to limitations and disadvantages of the related art.

An object of an embodiment the present disclosure is to enable the consumer to easily detect and verify genuine OEM products and to communicate and share his or her experiences about such products on the manufacturer's social media web pages such as Facebook, Twitter, YouTube, blogs, Tumblr, the manufacturer's official website, as well as shopping carts and review pages on the manufacturer's or other authorized retailer's websites on the Internet. Another object of an embodiment of this invention is to enable consumers to detect and verify genuine OEM products and to communicate, share, or disseminate information and images about such products using a smart phone or mobile device, such as an iPhone, Android, iPad or other tablet computer, Blackberry or other personal digital assistant, that is equipped with imaging or sensing capabilities. The imaging and sensing capabilities contemplated allow the device to image, sense, detect, read, and/or decode unique indicia, symbology, or codes, such as barcodes, matrix barcodes or QR codes, radio-frequency identification (RFID) chips or tags, and/or near field communication (NFC) tags, also via Bluetooth, wifi, satellites, GPS, and or a combination of the listed items that are linked to the genuine OEM products. Yet another objective of an embodiment of the present invention is to provide a mobile application synchronization software (an example of which is the Synca™ APP) developed for a mobile device or smart phone that enables detection and verification of genuine OEM products, and further allows communication about such products using the manufacturer's social networking websites, official manufacturer websites, as well as shopping carts, and review web pages on the manufacturer's or other authorized retailer's websites on the Internet.

An embodiment of the present invention allows consumers to share their experiences about a recent purchase of an OEM product, wherein the consumer scans the unique indicia, symbology, or read a chip, such as Bluetooth Low Energy (BLE) or code, such as a barcode or matrix barcode, or a combination of items listed using the embodied mobile synchronization APP on his or her mobile device or smart phone, thereby uploading the image of the product available in the manufacturer's database onto the manufacturer's social networking website, where the consumer can also post comments about the product. Another embodiment of the invention allows images of the product available in the manufacturer's database to be uploaded onto the consumer's social networking website, such as Facebook, where the consumer can then post comments about his or her experience with the product.

Another embodiment of the invention enables the consumer to use an embodied mobile synchronization APP in conjunction with an image sensor, camera, or videotaping-capability of his or her mobile device or smart phone so as to upload his or her own images and videos of the product onto the manufacturer's social media and networking websites, or the manufacturer's official website. In a further embodiment of the invention, the consumer can use a mobile synchronization application in conjunction with programs such as Instagram, YouTube, Flickr, Facebook, and Twitter to share images, videos, and other information about his or her experience with the OEM product. The consumer can scan or detect indicia, barcodes, matrix barcodes, RFID tags, or NFC tags on a particular OEM product using an embodied mobile synchronization application and post images of the OEM product and comments about the product automatically on the manufacturer's social media and networking pages, such as Facebook, Twitter, or the manufacturer's website. Additionally the user may compare the scanned product with reviews and pricing for competitive product alternatives.

Another embodiment of the invention enables consumers to send instant text messages in real time to the manufacturer or other third parties using an embodied mobile synchronization application to alert that a particular OEM product is a counterfeit or knockoff product. In another embodiment of the invention, the mobile application enables the user to register the OEM product he or she has purchased with the manufacturer if he or she so chooses. The registration information for the product can be changed if the product is sold or donated to another consumer. Further, once a consumer uses an embodied mobile synchronization application to scan and register an OEM product with the manufacturer using either the manufacturer's social media pages, networking websites, or official website, the manufacturer may directly communicate with the consumer to provide general information about the product, product defect or recall information, as well as promotional discounts and coupons for the same or related products. The manufacturers or consumers may provide data regarding retail term compliance. The manufacturer may even provide a quick survey at the end asking the consumer why they chose X product over Y. Or the consumer may volunteer the same information onto social media or to the OEM itself. The OEM may provide incentive programs for consumer feedback.

In another embodiment of the invention, a consumer's use of the mobile application to scan or detect the indicia, bar codes, matrix barcodes, RFID tags, or NFC tags. Bluetooth, wifi, satellites, GPS, and or a combination of the listed items to verify the OEM product's genuineness allows the manufacturer to determine the location where that product was scanned, thus allowing the manufacturer to generate information and prepare reports regarding product inventory, sales, consumer demographics, and other relevant marketing and product information.

Although the embodiments focus on the authenticity of the products, additional embodiments pertain to the present status of the scanned item. A scanned item may be identified as authentic/genuine additional information about whether the item is subject to recall is also available. Additional embodiments allow for the detection of stolen merchandise and a system of either alerts to the OEM, law enforcement or individual using an embodied synchronization APP.

In yet another embodiment of the invention, the mobile application launches a virtual world where consumers can communicate and interact with each other, sharing information and experiences about the OEM product.

To achieve these and other advantages and in accordance with the purpose of the present invention, as embodied and broadly described, an embodiment of the present invention provides a method for verifying whether an item is a genuine OEM product and communicating about said product on social networking websites comprising the steps of scanning unique indicia or symbology, such as a bar code, a matrix bar code, an RFID tag, or an NFC tag, Bluetooth, wifi, satellites. GPS, and or a combination of the listed items linked to a particular OEM item; transmitting information about said scanned code, tag, or chip to a computer database or an internet web site to verify that the code or tag corresponds to a genuine OEM product; receiving information from said computer database or internet web site regarding whether the item is a genuine OEM product; and uploading images and information, and posting comments about the product on the manufacturer's social media and networking websites such as Facebook, Twitter, YouTube. Tumblr, blogs, as well as on the manufacturer's and authorized retailers' websites and shopping carts on the internet. In another aspect of the present invention, the user can also send instant messages regarding the product to the OEM manufacturer, and other interested parties, such as other existing and potential consumers. As such, the user can alert the OEM manufacturer and third parties that a particular item is counterfeit, and also communicate about his or her experience with the product.

Another aspect of this invention describes a system for verifying the genuineness of OEM products and communicating about said products on social networking websites using a mobile application program developed for a smart phone or mobile device equipped with imaging or sensing capabilities that can image, sense, scan, detect and/or decode unique indicia and codes and tags, such as bar codes, matrix bar codes, Quick Response (QR) codes, RFID tags, and NFC tags, Bluetooth, wifi, satellites, GPS, and or a combination of the listed items which are linked to OEM products.

Additional features and advantages of the invention will be set forth in the descriptions that follow and in part will be apparent from the description, or may be learned by practice of the invention. The objectives and other advantages of the invention will be realized and attained by the structure and method particularly pointed out in the written description and claims thereof as well as the appended drawings.

### BRIEF DESCRIPTION OF THE DRAWINGS

The principles of the present invention will be apparent with reference to the following drawings, in which like reference numerals denote like components:

FIG. 1 depicts a flow chart of the steps in the method via which the SAME™ APP mobile application coordinates information products.

FIG. 2 depicts a drawing of a handbag including a Unique Identifier (UID) mechanism embedded in optional places along some of the handbag seams.

FIG. 3 consists of FIGS. 3A and 3B wherein the figures depict a front view drawing 3A and a back view drawing 3B of pair of jeans including a Unique Identifier mechanism embedded in optional places along some of the jean seams.

FIG. 4 depicts a drawing of a pair of jeans including a Unique Identifier (UID) mechanism attached discreetly along the belt line.

FIG. 5 consists of FIG. 5A-5D which are drawings depicting various shapes of contemplated Unique Identifier (UID) mechanism casings.

FIG. 6 depicts a drawing of a wristwatch including a Unique Identifier (UID) mechanism adhered discreetly to the back face of the watch.

FIG. 7 depicts a shirt including a Unique Identifier (UID) mechanism attached discreetly along the bottom hem line.

FIG. 8 depicts a drawing of a shoe including a Unique Identifier (UID) mechanism embedded in optional places along some of the shoe seams, tongue or sole interface.

FIG. 9 depicts a screenshot of an embodied landing page exemplary of the SAME app when in use.

FIG. 10 depicts a screenshot of a sign up page exemplary of the SAME app when in use.

FIG. 11 depicts a screenshot of an embodied password recovery page exemplary of the SAME app when in use.

FIG. 12 depicts a screenshot of an embodied shop page exemplary of the SAME app when in use.

FIG. 13 depicts a screenshot of an embodied navigation screen exemplary of the SAME app when in use.

FIG. 14 depicts a screenshot of an embodied profile page exemplary of the SAME app when in use.

FIG. 15 depicts a screenshot of an embodied sharing code screen exemplary of the SAME app when in use.

FIG. 16 depicts a screenshot of an embodied social media share page exemplary of the SAME app when in use.

FIG. 17 depicts a screenshot of an embodied sharing code and/or serial numbers exemplary of the SAME app when in use.

FIG. 18 depicts a screenshot of an embodied personalized style screen exemplary of the SAME app when in use.

FIG. 19 depicts a screenshot of an embodied personalized about your likes page exemplary of the SAME app when in use.

FIG. 20 depicts a screenshot of an embodied shopping bag page exemplary of the SAME app when in use.

FIG. 21 depicts a screenshot of an embodied how it works link page exemplary of the SAME app when in use.

FIG. 22 depicts a screenshot of an embodied authentication page exemplary of the SAME app when in use.

FIG. 23 depicts a screenshot of an embodied product detail page exemplary of the SAME app when in use.

FIG. 24 depicts a screenshot of an embodied product detail page with enhanced product viewing features exemplary of the SAME app when in use.

FIG. 25 depicts a screenshot of an embodied product detail page with detailed specifications of the product exemplary of the SAME app when in use.

FIG. 26 depicts a screenshot of an embodied shopping bag summary page exemplary of the SAME app when in use.

FIG. 27 is a schematic of the method of verifying whether an item is a genuine OEM product and communicating on social media sites using an embodied synchronization application such as the Synca™ APP on a mobile device.

FIG. 28 depicts a flow chart of the steps in the method via which the manufacturer module of the Synca™ APP mobile application scans, records, and stores information for specific indicia and symbology linked to genuine OEM products.

FIG. 29 is a flow chart of the steps in the method via which the Synca™ APP determines that an item is a counterfeit or imitation product and allows the consumer to communicate about the product using social media and networking web sites and to receive product-related communications from the manufacturer.

FIG. 30 is a flow chart of the steps in the method via which the Synca™ APP determines that an item is Genuine and allows the consumer to communicate about the product using social media and networking web sites and to receive product-related communications from the manufacturer such as Offers/Coupons/Other Products and related offers.

FIG. 31 consists of FIGS. 31A and 31B which depict the sequence of screens that appear on an iPhone, Android, Blackberry, or other smart phone following verification of the genuineness of an OEM product using the Synca™ APP.

FIG. 32 depicts a functional diagram demonstrating embodied information flow between main entities and their activities.

FIG. 33 depicts exemplary graphing of embodied analytic reports via Sales and Scanning Analytics based on male/Female/Age using the Synca™ APP on a mobile device.

FIG. 34 is a schematic of the method of communicating and retrieving lost articles using the Synca™ APP on a mobile device.

FIG. 35 is a flow chart of the steps in the method via which the Synca™ APP assists Law Enforcement/Manufacturer/Owner/Finder when a product identified is stolen or missing.

FIG. 36 depicts a screenshot of an embodied home link page including a link to other related mobile applications which the Synca™ APP assists a user to link to.

FIG. 37 depicts a screenshot of an embodied authentication page associated with a scanned item using a Synca™ APP.

FIG. 38 depicts a screenshot of an embodied Product Page associated with a scanned item using a Synca™ APP.

FIG. 39 depicts a screenshot of an embodied Additional Product Identification page with a scanned item using a Synca™ APP.

FIG. 40 depicts another screenshot of an embodied Additional Product Identification page with a scanned item using a Synca™ APP.

FIG. 41 depicts a screenshot of an embodied Additional Product Identification glossary or listing of Brands and links to their accompanying apps within an embodied Synca™ APP.

### DETAILED DESCRIPTION OF THE INVENTION

An embodiment of the present invention enables verification of the genuineness of an OEM product through comparing unique identifying indicia, symbology, and codes, such as barcodes, matrix bar codes, RFID tags, and NFC tags, Bluetooth, wifi, satellites, GPS, and or a combination of the listed items physically linked to the OEM product against a database containing the same. Based on a system according to an embodiment of this invention, unique identifying indicia, symbology or code are physically linked to the OEM products by the product manufacturer, authorized supplier, distributor, or administrator, and said indicia, symbols, and codes, including barcodes, Universal Product Codes (UPC), UPL, QR codes, RFID tags and NFC tags, Bluetooth, wifi, satellites, GPS, and or a combination of the listed items are scanned or synchronized or communicated via other technology and maintained in a database by the OEM manufacturer of administrator. Each barcode, matrix bar code, UPC, QR code, RFID tag, or NFC tag, Bluetooth, wifi, satellites, GPS, and or a combination of the listed items is set up to signify a specific product or stock-keeping unit (SKU) number. In other words, no two items would have the same digits per on the barcode, matrix bar code, UPC, QR code, RFID tag, or NFC tag. This would be the case even if two items have similar styles, colors, sizes, or compositions.

An embodiment of this invention provides a mobile application software (the Synca™ APP) developed for a mobile device or smart phone that enables detection and verification of genuine OEM products, and further allows communication about such products on the manufacturer's social networking websites, SYNCA's platform or site, the end consumers social pages, official manufacturer websites, as well as shopping carts, and review web pages on the manufacturer's or other authorized retailer's websites on the Internet. The Synca™ APP can be procured from mobile APP stores or purchased and downloaded from the Internet. It can be installed in a mobile device or smart phone, such as an iPhone, an Android, a Blackberry or other personal digital assistant, and/or an iPad or other tablet computer, which has a mobile camera or other sensor that can image, scan, sense, detect, and/or read indicia, symbology, and/or codes, such as barcodes, matrix barcodes, RFID tags, or NFC tags, Bluetooth, wifi, satellites, GPS, and or a combination of the listed items.

Another embodiment of the present invention includes the use of a specialized app that is mated to a specific to a clothing line (for example) or another consumer good for illustration purposes it is called a SAME™ APP. The SAME™ APP would associate with a specific company or product such as a clothing line company most likely through a licensing agreement. The SAME™ APP then utilizes one or more technologies such as digital fingerprint, a serial number, a specific code or another specific identifier as a means to communicate with new users to the specific line or brand. An embodied focus utilizes digital fingerprint or serial number or other code indicators as a means to shop and invite new users to the brand, while connecting users to each other, and discerning their likes and possible purchases based on habits and purchases.

The present embodiments serve as a functional alternative to using the Google Ad words or rankings to compete in business. The Google rankings are often manipulated by larger companies or more well-funded entities to the detriment of other businesses.

Present embodiments utilize a SAME™ APP system to coordinate with the serial number or UID as forms of communication for bringing in new users to the brand and/or for tracking sales and managing the companies production and other inventory and product analysis reasons.

As described above a UID or other digital finger print type technology can be used for each product. When a UID is used it may be utilized as an invitation or a shopping code. Such that, when a new shopper or user utilizes a friends UID, who has invited them to shop, the friend will get incentives in the form of product, points, cash, coupons or other purchasing incentives. Additional embodiments may include a method of alerting a user or member that his or her code is being used to shop. The creates a way for brands to utilize an incentive method rather than relying on Google ranking or Ad words. For example, if a user were to invite 10 friends and five of them shop and purchase with the users code, than the user would receive free product for every 5 purchases utilizing said users code. This code may additionally linked to the new users such that referrals from the new users provide incentives to both the new user and the original user who referred the product and so long down the chain. The incentive to grow and promote the brand allows users to make a brand they believe in more accessible to them with earnings or more products or discounts.

Furthermore, the SAME™ APP type embodiments may also be linked to the embodiments related to the SYNCA™ type apps which allows connectivity with other users of similar products wherein comparisons and other data can be shared in a peer review type format.

The unique identifiers associated with the apps may include any one or a combination of Bluetooth, BLE, RFID, NFC or BARCODE technologies and the ability to detect, read or receive signals from any of the listed identifier means.

Embodied devices may be enclosed in a housing that is water-proof, and unbreakable to a certain degree and strategically placed in products to be read by the specifically embodied software on mobile devices.

Further embodiments allow the products to alert their owners if they are lost or stolen, by sending a signal to the owner's mobile device of their location.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

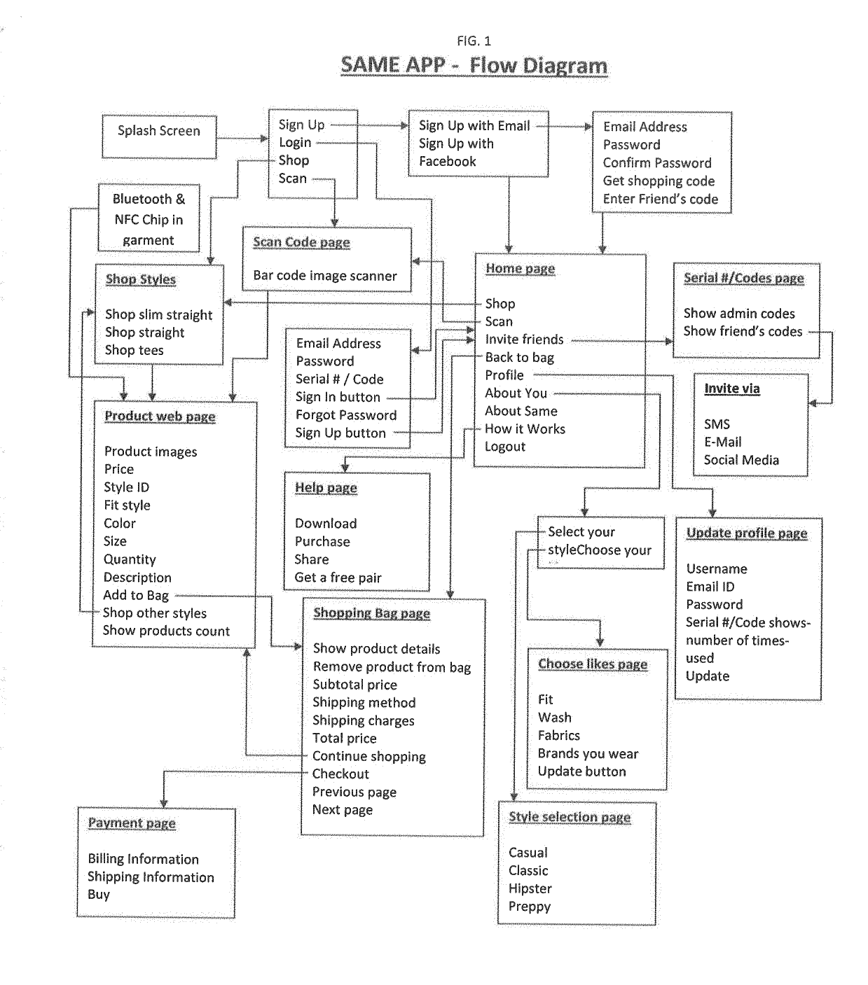

FIG. 1 depicts a flow chart of the steps in the method via which the SAME™ APP mobile application identifies and coordinates information related to products. When the user opens a SAME™ APP type mobile application embodied in the present invention they start at a splash which leads the user to a Sign Up. Login. Shop or Scan option page. They then follow the exemplary steps when using the SAME™ APP type mobile application application.

Once the user downloads and opens the SAME™ APP type mobile application they land in the pages shown in the image where they are asked to enter the username which is used to index the user followed by the user's password. Then the user can sign In.

If a user is using the app for the first time they need to first sign up.

If the user has forgot their password they will be prompted to enter their registered email ID and the password is sent to their email by clicking on confirm or by clicking on cancel which then sends users back to the login page to try again. Upon clicking on sign up the user is prompted to the page “Tell us about you” page where the user is asked to enter the following: 1. Name: enter the name of the user. 2. Password: enter the password of their choice. 3. Confirm password: enter the same password once again to confirm. There are navigation arrows on either side of the top screen which allows the user to navigate to previous and next page. By clicking on the back arrow the user is sent to the login page and by clicking on the front arrow or forward arrow they are sent to the next page.

Upon clicking on the forward arrow from the “Tell us about you” page “the user is sent to the “tell us about your style page” or the user can select a style of one of the following: 1. Casual 2. Classic 3. Hipster 4. Preppy. Once the user finishes up with that page they move to “Tell us about what you like page”, where the user needs to complete the description regarding their preferences in regards to the following parameters when dealing with a product such as jeans as exemplified here.

The user selects their preferences in regard to:

1. Fit wherein the user may select one or more among the following for example: a. Straight b. Boot c. Slim d. Relaxed.

2. Wash type wherein the user may select one or more among the following in a drop-down box: a. Dark b. Mud c. Light.

3. Fabrics type which lets the user select one or more among the following with the help of a drop-down: a. Rigid b. Soft c. Stretch.

4. Brands the user likes to wear allows the user select the brands commonly worn such as: a. Seven for all mankind b. Bonobos c. Diesel d. J-Crew e. Levi's f. Lucky Brand g. Joe's h. Ciizens of Humanity i. Hudson j. G-Star k. other.

After a user completes the above exemplary preferences they come to the sign-up page they need to enter their email ID followed by which they have 2 buttons:

1. Get code: which upon clicking on this after entering an email ID a purchase code is sent to the users mail. With this the user has successfully signed up.

2. Enter code: in case user doesn't want to get a code and wants to use a friends code he could click on enter code.

Once the user has entered a valid UID or serial number and then clicked submit a message an authentication message appears with a picture of the product and the message “an authentic SAME jeans product” appears.

Upon clicking on the settings button a transition to the user detail page appears where the following fields are to be seen:

1. User Name: The user will not be able to edit the user name because it is the validating term.

2. Email: Since the Email ID of the user was not entered earlier they could update their email ID.

3. Password: the user can change their password as well.

Upon clicking on Update the user details are updated. And once the user has signed up successfully they will directly land on the scan or enter code page. The user can scan the page or the user can either scan the barcode or NFC code of a product and if the code is valid and moves to the product detail page or else it displays a message of no product in the scanned code. An additional option is to enter the code to move to the product detail page. In the product detail page the product with the respective scanned or entered code is displayed which may include details of: 1. Product type 2. Code 3. Size 4. Fit 5. Color 6. Price.

Upon clicking on “buy now” the user moves on to web view where the user can buy the product or add to the cart and change size, quantity or view description about the product.

In the web view there are options of add to bag shop other styles, but before that the user can decide what size would fit the quantity. Upon clicking on add or add to bag the selected product is added to the bag and is displayed as an image, the user can also choose the shipping method. From there the user could either continue shopping or check out. If the user continues shopping they will again be shown the list of products available and the user can purchase from among them, the bag shows a complete shopping history table and the user can move or add or once the user checks out they will be have to provide complete billing information which includes the type of card; card number, first name, last name, address, state, city, zip code, country etc.

Also the user may enter the shipping information which may be the same as the billing information and then finally the user can buy the product.

The user may finally choose to share the purchase information with others either selectively or generally. Upon clicking on Share the User can Share the details of their purchase on Social Networking Sites such as: 1. Facebook; 2. Twitter, and/or 3. Instagram.

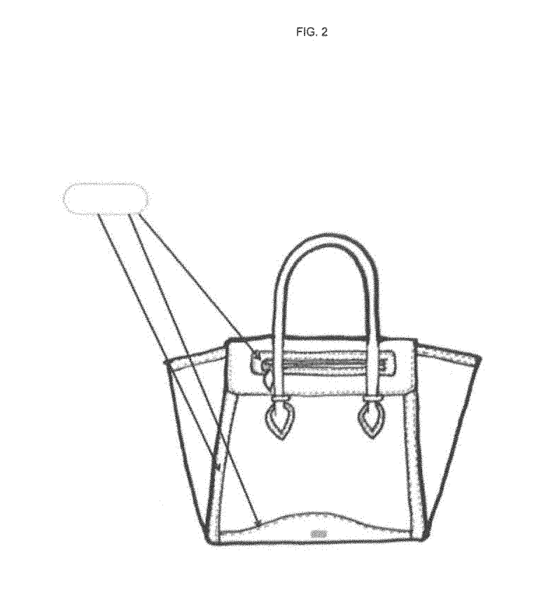

FIG. 2 depicts a drawing of a handbag 2 including a Unique Identifier (UID) mechanism 110 embedded in optional places along some of the handbag seams. In use when a person identifies a product of interest they may first fully identify the product using the SAME™ app to read the product UID with the app. With this information the user can decide whether they would like another style or whether they would like to purchase one either online or at a local store. Additionally, the user may utilize the SYNCA™ APP to further determine the authenticity of the product and the other characteristics discussed in further detail above.

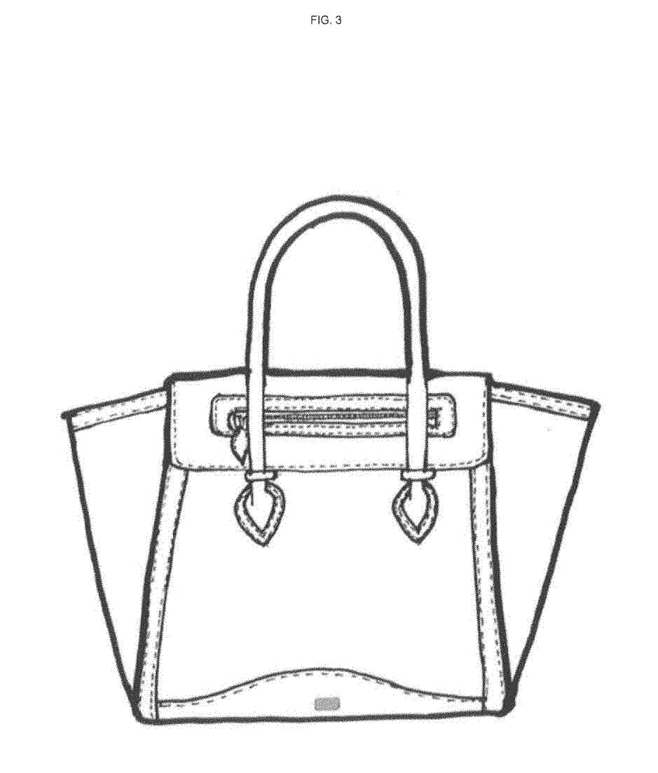

FIG. 3 consists of FIGS. 3A and 3B wherein the figures depict a front view drawing 3A and a back view drawing 3B of pair of jeans 4 including a Unique Identifier mechanism 110 embedded in optional places along some of the jean seams. In use when a person identifies a product of interest they may first fully identify the product using the SAME™ app to read the product UID with the app. With this information the user can decide whether they would like another style or whether they would like to purchase one either online or at a local store. Additionally, the user may utilize the SYNCA™ APP to further determine the authenticity of the product and the other characteristics discussed in further detail above.

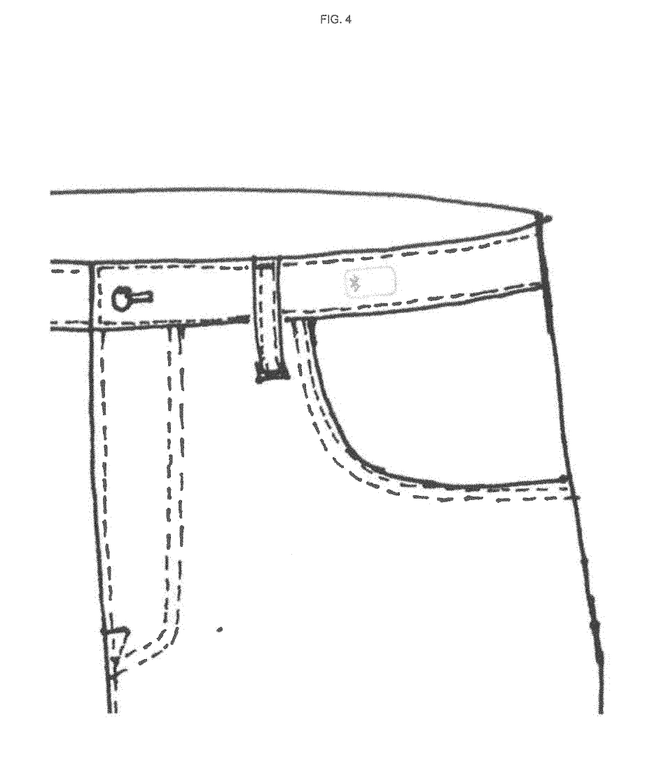

FIG. 4 depicts another drawing of a pair of jeans 4 wherein an embodied Unique Identifier (UID) mechanism 110 is attached discreetly along the belt line. And then the UID is read with at least one of the APPS embodied in the present invention.

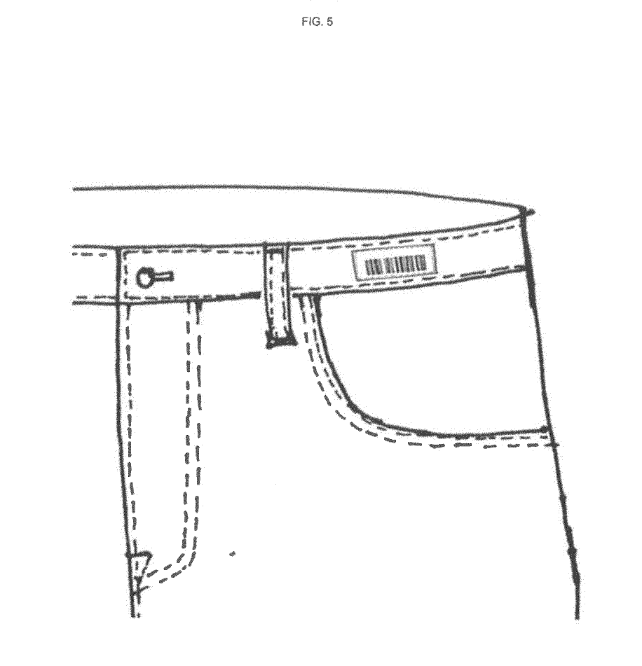

There are many types of Unique Identifier Mechanisms 110 that are embodied by the present invention and FIG. 5 consists of FIG. 5A-5D which are drawings depicting various shapes of contemplated Unique Identifier (UID) mechanism casings 105, 205, 305 and 405 respectively.

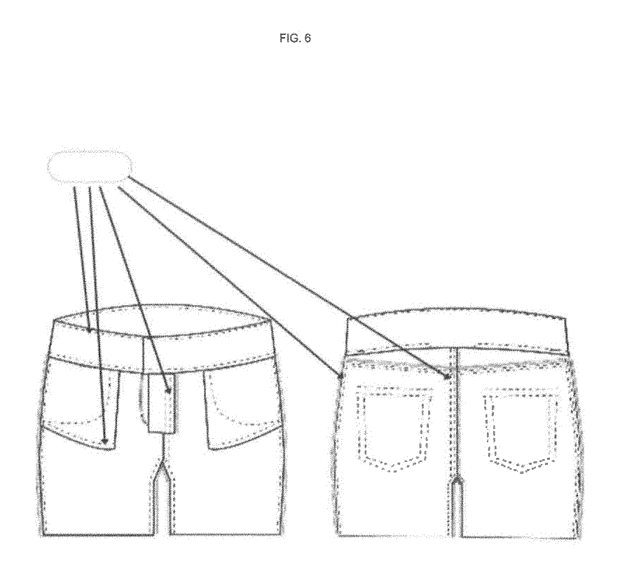

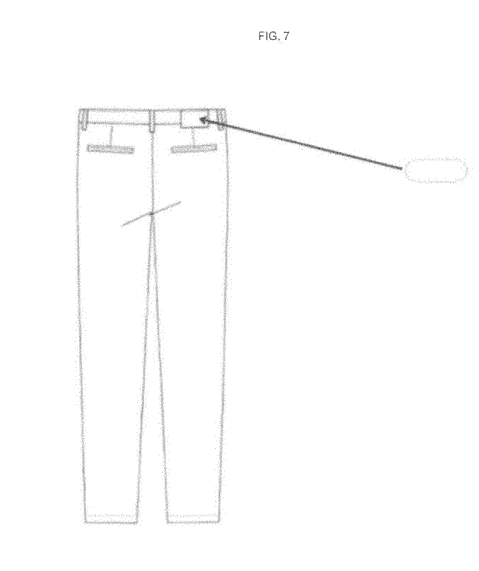

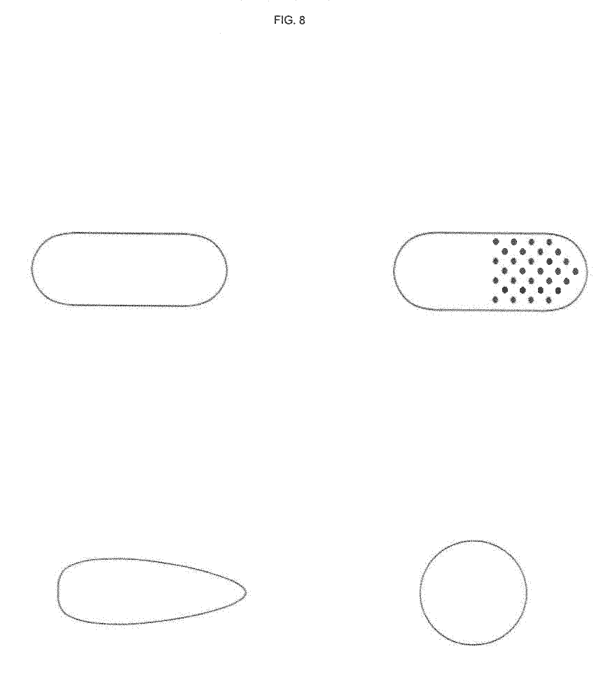

The Unique Identifier Mechanisms 110 can be placed in a large variety of consumer goods, including jeans, shirts, watches, shoes and handbags. FIG. 6 depicts a drawing of a wristwatch 6 including an embodied Unique Identifier (UID) mechanism 110 adhered discreetly to the back face of the watch 6. Whereas FIG. 7 depicts a shirt 7 including a Unique Identifier (UID) mechanism 110 attached discreetly along the bottom hem line. And finally FIG. 8 depicts a drawing of a shoe 8 including a Unique Identifier (UID) mechanism 110 embedded in optional places along some of the shoe seams, tongue or sole interface. And then the UID is read with at least one of the APPS embodied in the present invention.

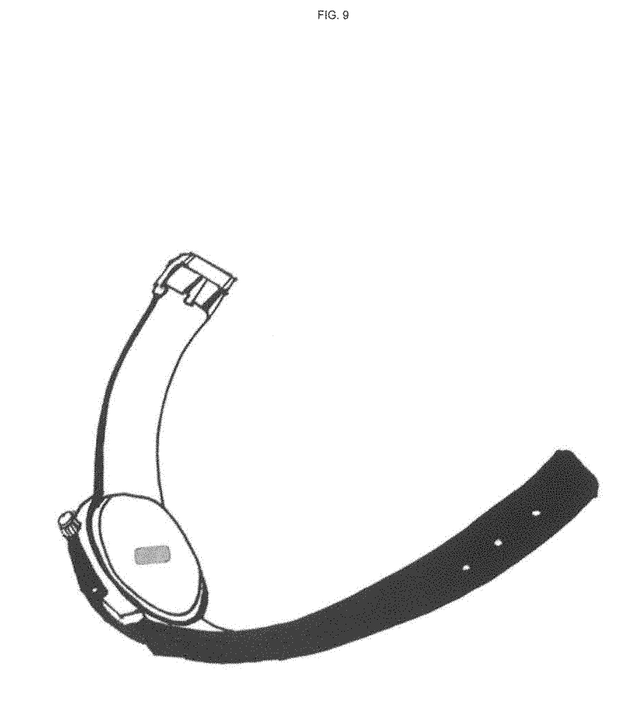

FIGS. 9-26 relate to the utilization steps and web pages associated with the exemplary description of the decision tree schematic discussed in FIG. 1 of the embodied SAME™ APP which can read an embodied UID from a product. The following Figures and details provide embodied exemplary view views of the screenshots at various times when using the SAME™ APP.

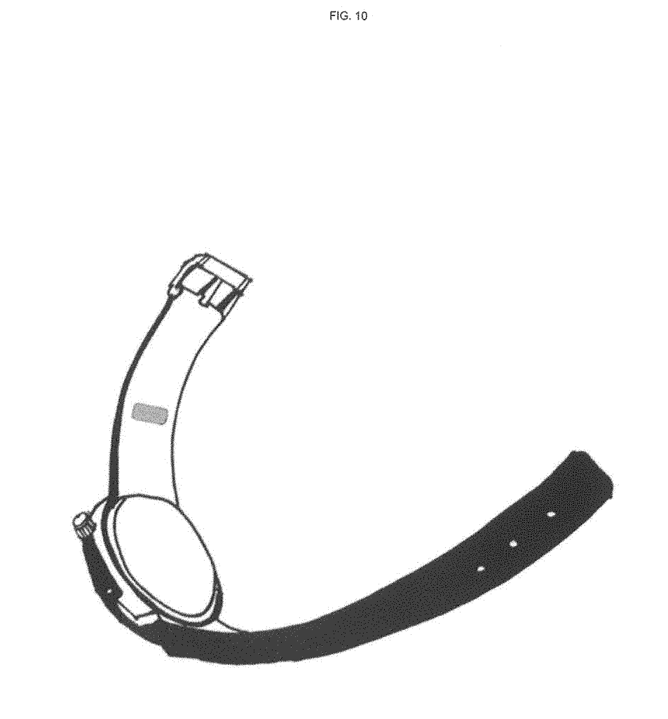

When using a SAME™ APP type application the following exemplary use is provided FIG. 9 depicts a screenshot of an embodied landing page exemplary of the SAME™ APP when in use. Once the user downloads and opens an embodied APP the Landing Page Appears. From there a user presses sign up when they are a first time user or Log in to continue if they are a returning user. Next the user proceeds to a sign up page, as shown in FIG. 10 which depicts a screenshot of a sign up page exemplary of the SAME™ APP when in use. At the sign up page Email, password and a password confirmation is completed. If the user was invited by a friend they would press “enter friend's code” and enter the code given to them in the invite. It the user was not invited they would press “get shopping code”, where the company associated with the product generates a random code for the user to enter and shop.

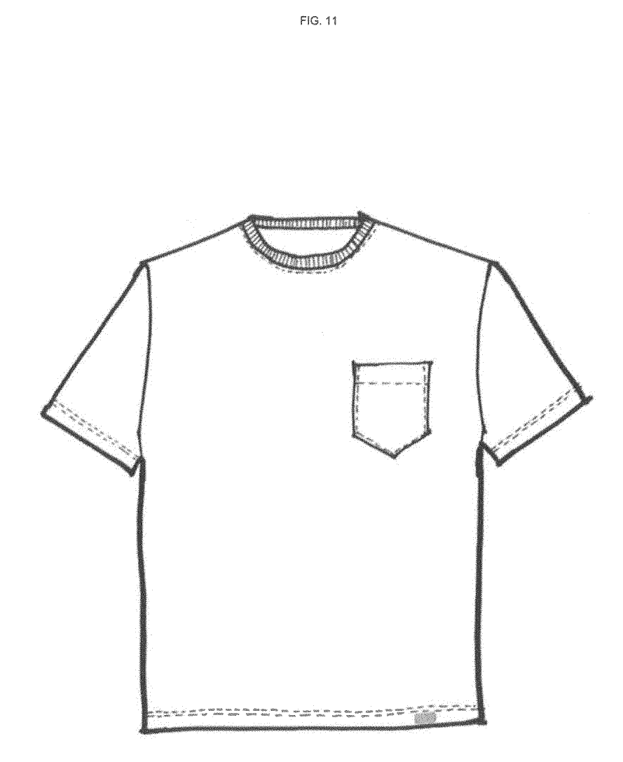

If the user has a problem with the Password Login from above they would proceed to a password recovery page as shown in FIG. 11 where the user is prompted to enter their registered email ID and the Password is sent to the user's email after clicking confirm. If clicking cancel the user is sent back to the Login Page.

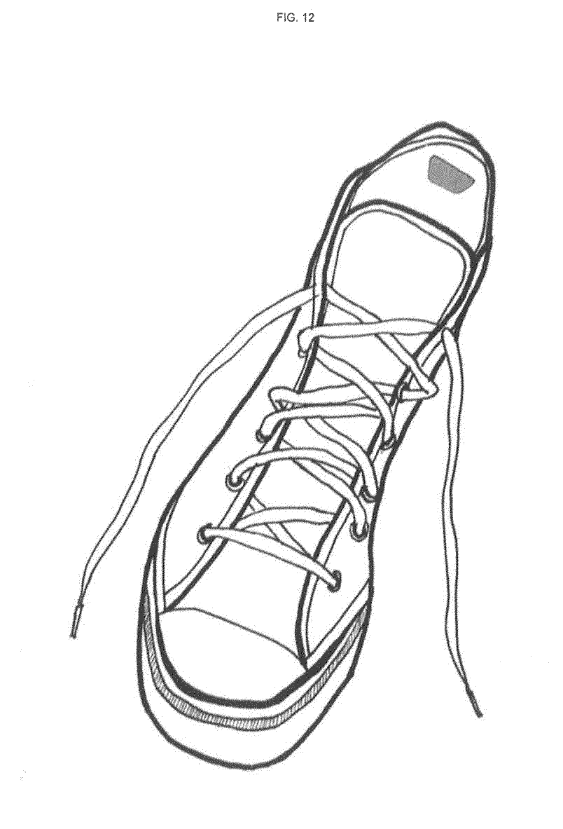

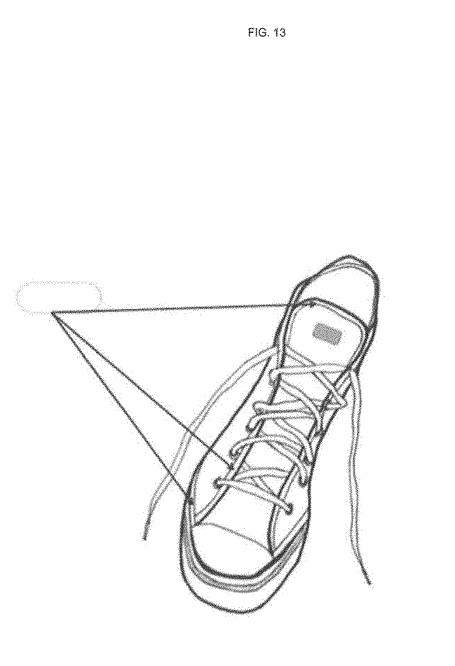

Once the user has effectively Logged in they may come to a shop page as exemplified in FIG. 12 which depicts a screenshot of an embodied shop page exemplary of the SAME™ APP when in use. At the shop page the user can navigate and see styles and click on the one they want to see details on. If they want to purchase the style they click on the buy button and the APP will take them to the shopping cart. Once the user checks our and if they used a friend's code the friend will get an alert on their phone of the use. Another embodied function and screenshot of the SAME™ APP includes a navigation screen exemplified in FIG. 13 wherein the user can go to this page from anywhere in the app by swiping the screen. The user can then press any of the headings to navigate through the app as applicable.

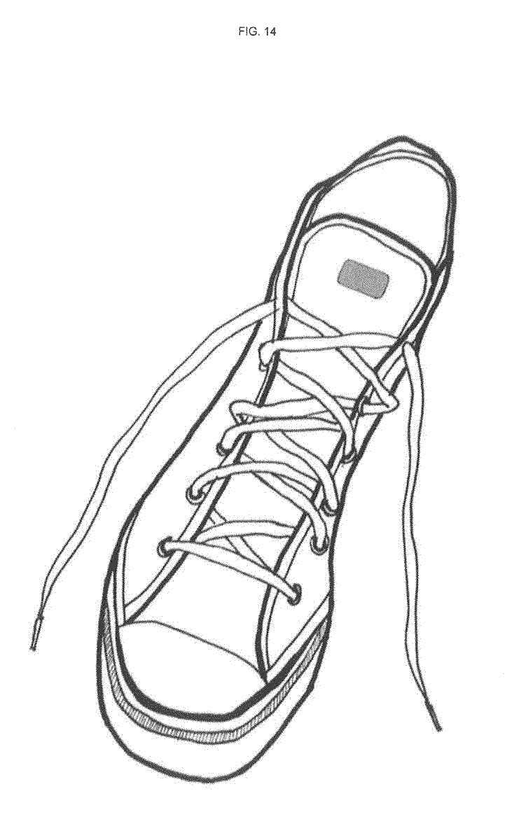

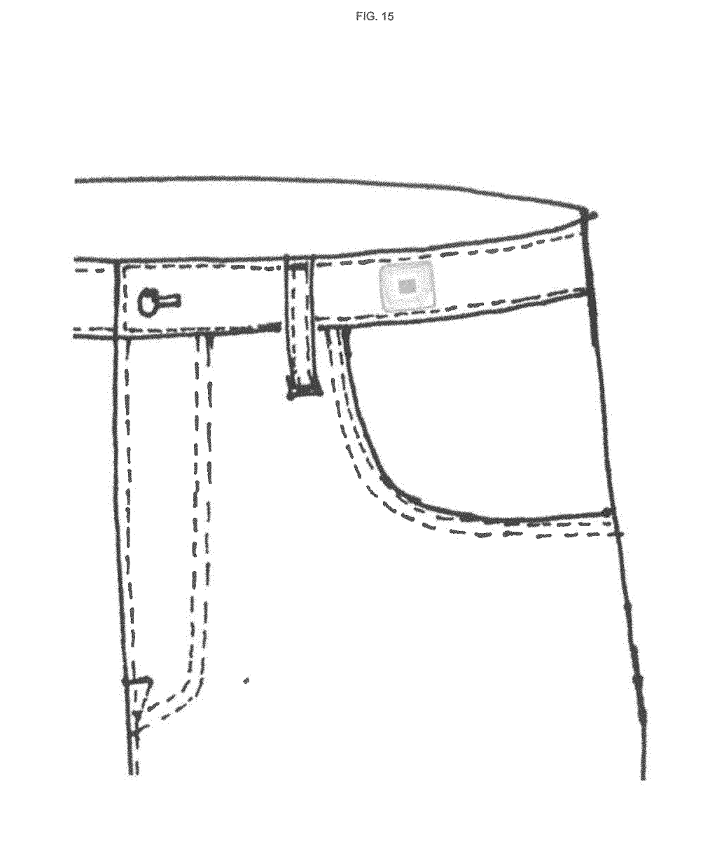

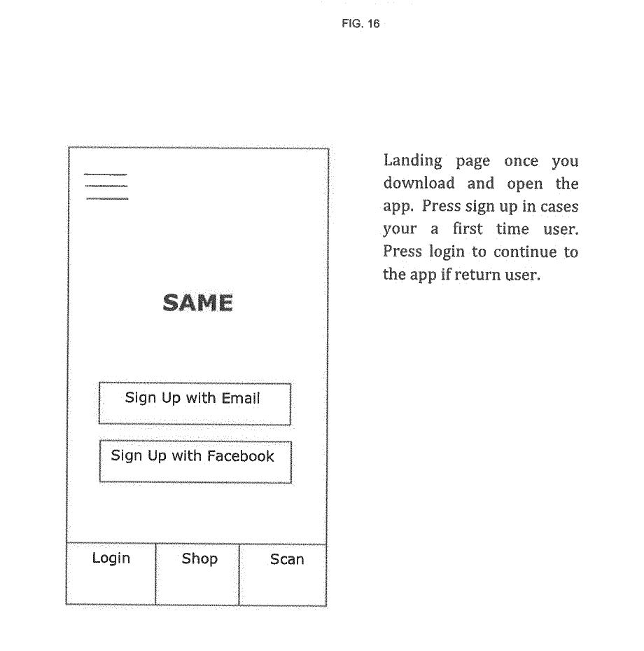

An additional screen contemplated in the SAME™ APP includes a Profile screen shown in FIG. 14 depicts a screenshot of an embodied profile page wherein a user can update their profile, edit details. Additionally the user may share a retrieved code by clicking the share icon next to a code or serial number. This will lead one to a sharing code screen as exemplified in FIG. 15 wherein when the user clicks on the share icon the user is able to invite friends with their code or serial number on the product. The user also has the option to post the code to any or all of their social media accounts. FIG. 16 provides more options when sharing the information on social media and allows the user to share their code on Facebook, Twitter, Instagram and others all at the same time or individually. A static message or a newly created message by the user can be uploaded.

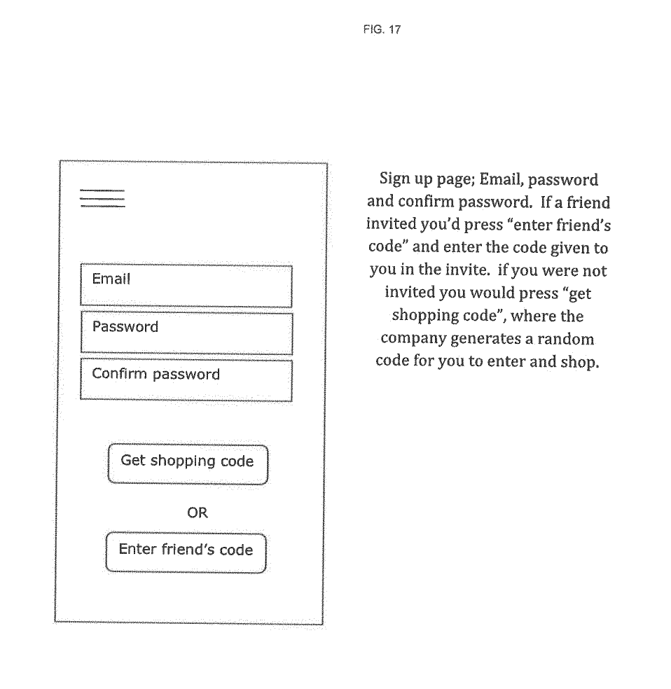

A users codes may be listed on a screen such as is shown in FIG. 17 wherein the listing of sharing codes or serial numbers is provided in another way without the use of social media and allows the user to sliced the screen to the navigation screen and choose to invite friends. This window additionally gives the user a list of all of their serial numbers or codes they have purchased and the user is able to utilize any of the listed numbers for inviting other users.

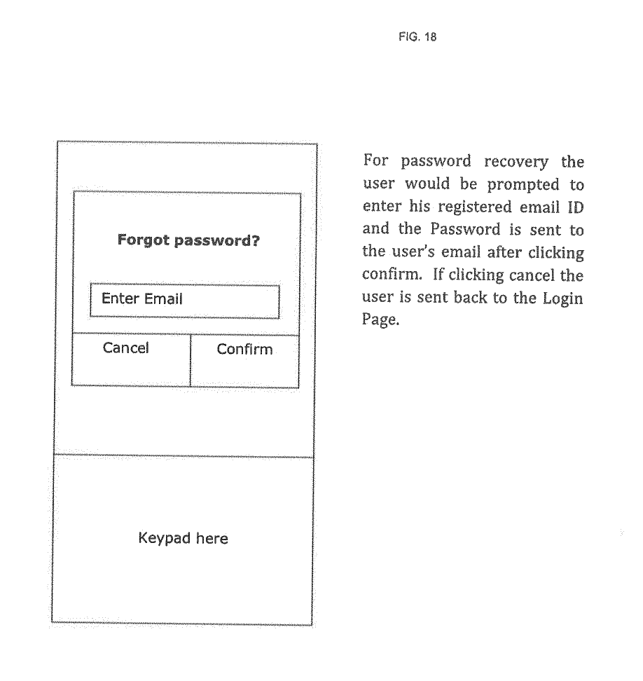

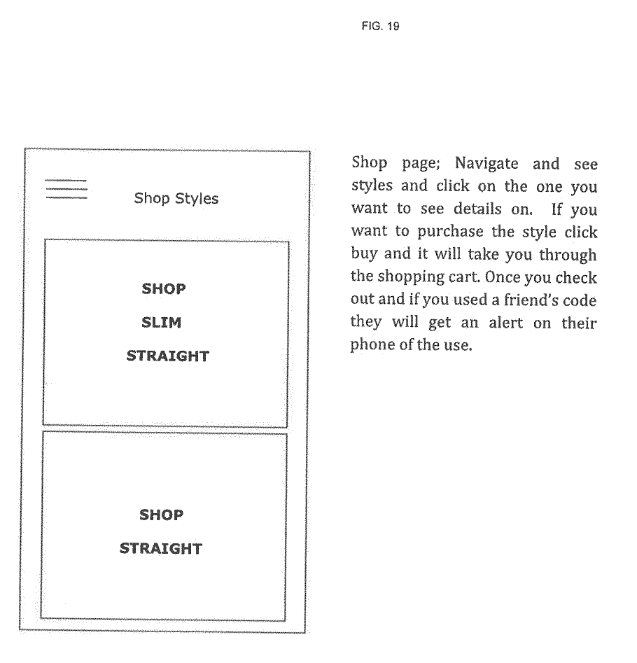

Additional exemplary and highly customizable screens relate to a Tell us about your style screen or likes screen as depicted in exemplary form in FIGS. 18 and 19. The user is asked to enter likes and preferences in regards to their personal taste and experiences. The program can determine specific products tailored to their likes and buying habits. The program will then send the user alerts on specific products based on their choices selected in the two screens.

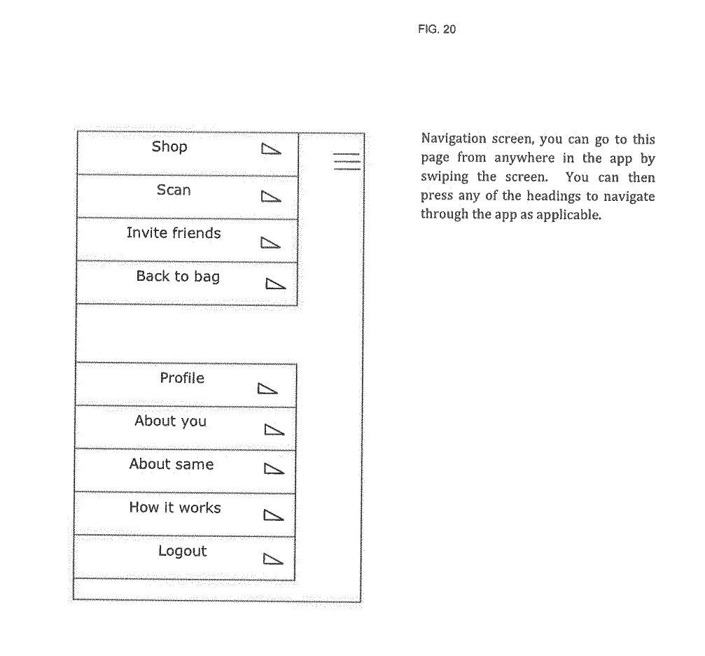

A shopping bag screen as shown in FIG. 20 depicts a screenshot of an embodied shopping bag page exemplary of the SAME™ APP when in use wherein clicking upon the shopping bag from the navigation screen the user is able to return to the shopping mode, and back to the purchases, where they can edit any items before checking out.

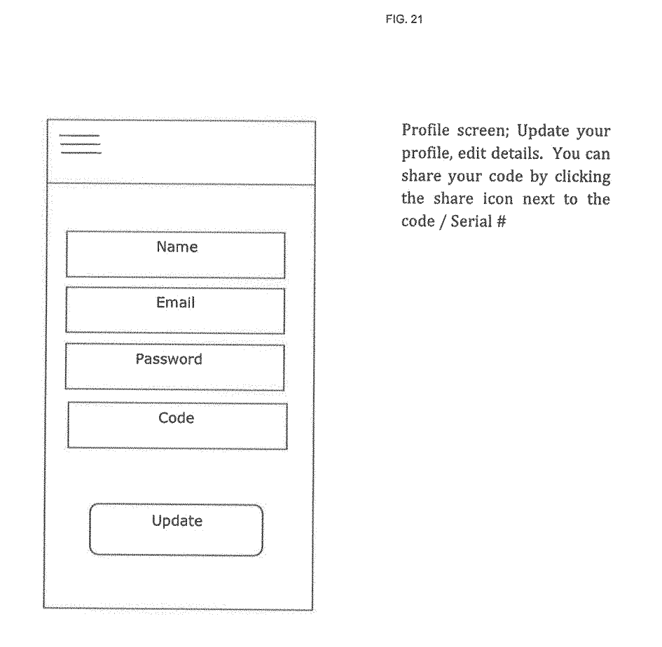

An additional embodiment includes a how it works screen as depicted in FIG. 21 which may vary from product to product and may explain details in relation to a specific product regarding sizing and styles but also may include details in relation to what the brand is willing to do from an incentive basis such as how many points are given for a purchase or referral and what the points can be used for details.

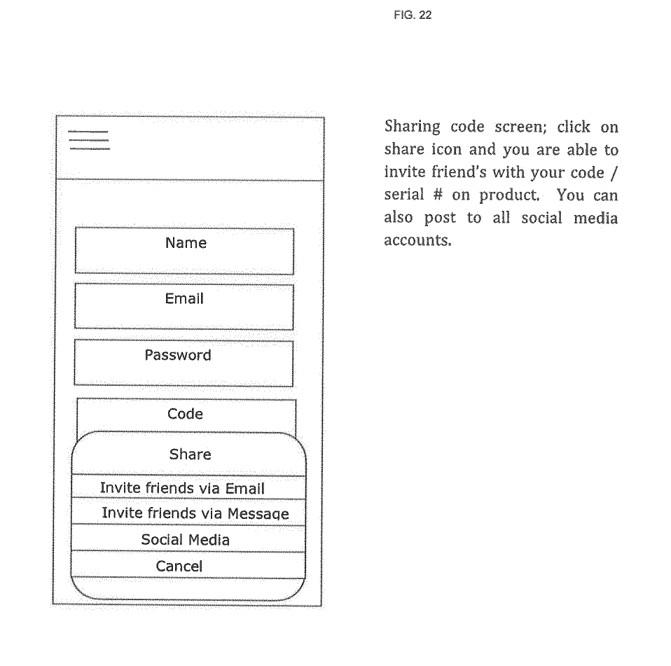

Embodiments of the present invention may include the use of the SAME™ APP to verify the authentication of a consumer code as shown in FIG. 22 optionally, further verification and/or more complete verification and communication may be utilized by also scanning the identifier with the embodied SYNCA™ APP provided herein as well.

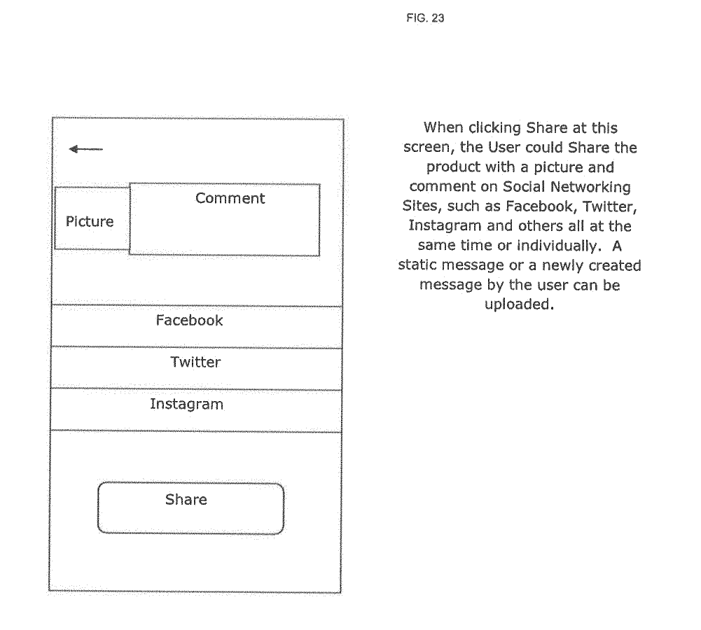

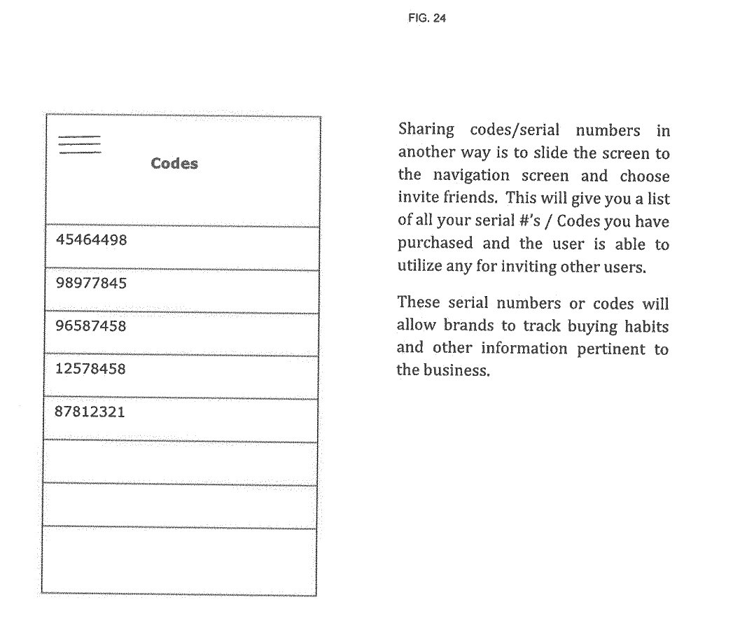

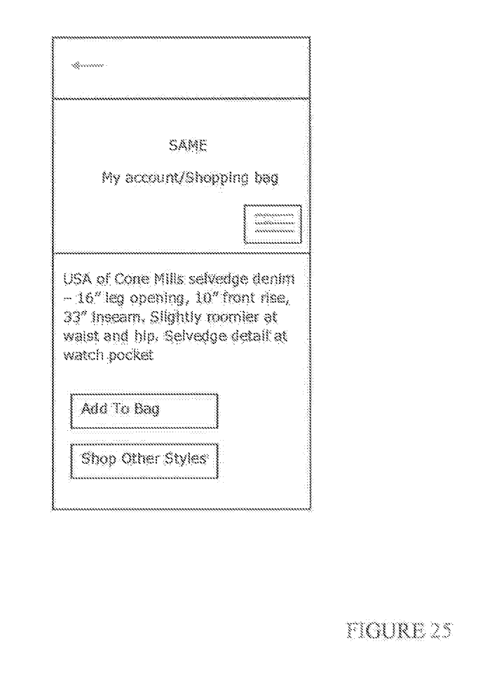

Once a product has been identified and optionally verified more information related to the product details can be shown as depicted in FIGS. 23, 24 and 25. In the product detail page depicted in FIG. 23 the product with the respective scanned or entered code is displayed which includes various details related to the product type, the code or serial number, the style number, the fit or cut, the color or price. These parameters can all be customized to fit the users preference. Upon clicking on the “buy now” button the user mores on to a web view where they can buy the product or add to product to their cart and change size, quantity or view a more detailed description about the product. When the user shares this information they can invite others to the brand and the experience. FIG. 24 shows an example of an enhanced viewing of the selected product wherein the product may be viewed from multiple angles or even a 360 degree view in some cases. FIG. 25 provides another exemplary screenshot where information related to further details of the product including materials, specifications of product or origin of the product is shown and allows the user to add the product to their shopping bag or to continue shopping other styles.

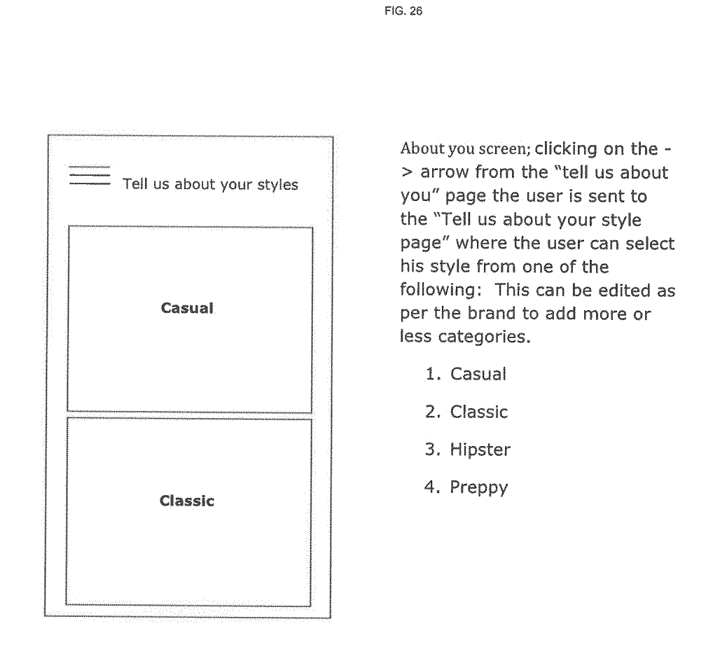

Finally, when the user is ready to complete an online purchase an exemplary screen depicted in FIG. 26 appears which shows a table with a summary of the users shopping bag wherein the user can optionally remove or add items before check out. The user then provides complete billing information and shipping information to complete the purchase. Once the user has purchased the product if they have utilized a serial number or code from another person that purchase is then credited to the person who invited them or provided the code to the shopper. The original person with the code is then notified by a push notification after a purchase has been made. Additionally, if a return occurs, another push notification notifies the holder of the code of the return.

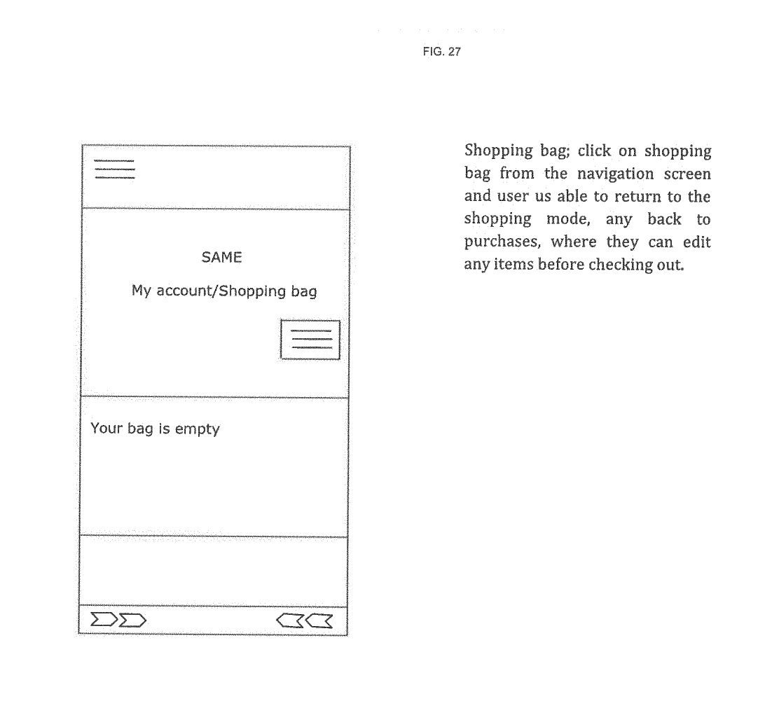

FIG. 27 illustrates the steps in a method of verifying whether an item is a genuine OEM product using the Synca™ APP installed in a mobile device or smart phone as provided by an embodiment of the present invention. As illustrated in the figure, according to a method of an embodiment of this invention, the Synca™ APP installed in an iPhone, Android, or Blackberry phone is opened, and the camera, or imager is pointed at the indicia, symbology, or code, such as a barcode, matrix barcode, or NFC tag linked to the product. If the product contains an RFID tag, it can be scanned using the hardwiring in the smart phone or mobile device. Once the indicia, symbology, or code is detected, it is communicated to the OEM manufacturer's computer database, SYNCA's database or any another Internet web-based database, which is searched for a match for the detected indicia, symbology, or code. If there is a match with the codes and symbology in the database maintained by the OEM manufacturer or administrator, the product is deemed as a genuine OEM product. If there is no match, then, the product is deemed to be an imitation or a knockoff.

The results of the search are displayed on the screen of the smart phone or mobile device, which then, opens up the link to social networking web sites, where the user can post comments about whether the item is a genuine OEM product or an imitation. The social media link or connection automatically connects to the OEM manufacturer's social media pages, including among others, Facebook, Twitter, Tumblr, Google+, YouTube, blogs, web sites, and shopping carts and review pages, where the user can post comments about the verification of the item, and indicate that he or she likes the company. The user can follow the company through the link, which also allows the user to shop and make additional purchases on the OEM manufacturer's web sites and shopping carts. The link further allows the user to upload images or pictures of the scanned item from the mobile device or smart phone, such as iPhone, Android, or Blackberry phone, and to indicate where the item was purchased, what season's item is shown in the photo, and the retail price paid by the user. Using functionalities in the APP and the OEM manufacturer's social media sites, the user can directly connect, network, and communicate with other customers who have posted comments and photos regarding their own verification, purchase, or other details about or experiences with the OEM product. The user can further register the product using tools in the Synca™ APP and the OEM manufacturer's web site. If the user sells or donates the product to another consumer, the user can remove or transfer the registration information using the Synca™ APP, and the second owner of the product can then, register the product at the OEM manufacturer's web site, so that the appropriate party can be contacted in the event of a product recall, product lost or stolen, product warranty, brand event, or other event.

According to an embodiment of the present invention, the mobile application program (the Synca™ APP) has at least two modules, including a manufacturer or administrator application, and a customer application. With respect to the manufacturer or administrator module, the OEM manufacturer or administrator can access the mobile application (the Synca™ APP) by entering a user name and password to login to the system on a personal computer, smart phone, or personal digital assistant. If the login details are correct, the OEM manufacturer or administrator successfully logs in. If not, a pop up window with the message “Username or Password incorrect” appears and stays on the screen of the mobile device, smart phone, personal digital assistant or personal computer.

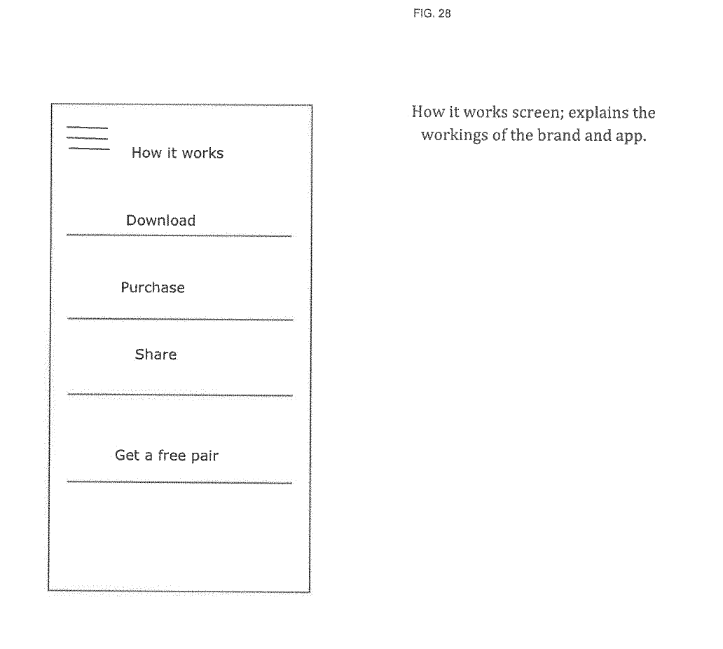

Following successful login, the OEM manufacturer or administrator chooses a specific item by accessing a drop down list of OEM products on the screen. He or she scans, reads, or senses the indicia, symbology, or codes, such as bar codes, matrix bar codes, RFID tags, and NFC tags on the item using either the mobile device equipped with an imager or sensor, or by using a separate imaging or sensing tool or device, such as a bar code scanner. RFID reader, or NFC sensor. If the indicia, symbology, or codes have been properly scanned, they are added to the OEM manufacturer's database, with details. The database may be stored on the personal computer and maintained in the OEM manufacturer or administrator's server, or on a cloud computing platform. The administrator also has the option to run analytics from this area on his or her mobile device based on multiple criteria of choosing. If errors are made in the process of entering item details to the database, they will be indicated on the screen. For example, if a product type is not selected from the drop down list, then a pop-up window will appear on the screen with the error message “Choose Product First.” Once the indicia, symbology, or code has been added to the database, the OEM manufacturer or administrator can log out of the application using the Logout button. FIG. 28 illustrates a flow chart of the steps via which the OEM manufacturer or administrator scans and enters product information and indicia, symbology, or codes in the OEM manufacturer database.

Using the mobile application, the Synca™ APP, installed in an iPhone, Android, iPad, Blackberry, or other smart phone, an administrator or authorized retailer can ensure that the products he or she is selling are genuine. For example, if a manager at a store that sells branded OEM products wanted to verify the genuineness of a particular product, he or she would log into the Synca™ APP on his smart phone, Android, or Blackberry using his or her username and password combination. Once the manager/administrator is logged in, he or she can scan a barcode, or QR code using the image sensor or camera in his or her iPhone, Android, Blackberry, or other smart phone device, equipped with the Synca™ APP. Clicking the scan button starts the camera or image sensor, and simply pointing the image sensor on the barcode or QR allows the Synca™ program to detect the barcode, QR code, or other symbology, Bluetooth, wifi, satellites, GPS, and or a combination of the listed items.

Additional embodiments include the ability to have the UID encrypted, one such way is to provide multiple UID's but the authentic one is only read and recognized or listed on the back end servers. The UID on the product will communicate with the one in the server via the embodied APP software to verify a products authenticity. This additional step creates another barrier to fraud making it harder for counterfeiters to pawn off their wares.

Additional embodiments may use encryption techniques wherein BLE, NFC, RFID and other parts come with a UID from their respectful manufacturers. Additionally additional digits to the UID may be added sometimes, and this would be the “real” serial # or UID for the product attached with the device.

This true UID will only be located in the specialized servers or controlled servers of the merchant or app or software administrator or another non-compromised link in the authenticity chain (such as the app administrator, OEM or merchant). The UID on the devices (BLE, NFC etc.) will be encrypted the embodied apps and/or programs. So when a user scans a UID they will not see the actual UID but a encrypted one only. A user that has an embodied app will have a key in the software to communicate with the embodied app server once the product is scanned and it will verify whether the product is real or not. They user themselves may never know the real code.

Another example is identified for use in the SAME app type identification model wherein a user knows the serial number of a product of interest, as it is on the product. The user can than share that code or serial number with their friends so the applications and software can track who is sharing what and thus a user may be rewarded accordingly.

Yet another example includes wherein when a user signs up they get a “User Code or Number”. For example, a user signs up and is given a number 1234, a unique code only to that user. Next the user purchases a pair of jeans, which has a serial#9876 and a T-shirt that has a serial number of 4567. Well when the user shares their products to invite others, the embodied applications can track the sales and invites and promotion of the product by the unique consumer code. The serial numbers or UID's of the products are attached on the back end to the “User Code” so the applications can track the use or promotion at anytime and a user will be rewarded accordingly.

In yet additional embodiments there are various types of materials used to adhere NFC/Barcode, BLE/NFC, BLE/RFID on garments and accessories etc. For example when a NFC identifier is used the NFC may be sandwiched between two pieces of vinyl with a barcode printed on top and then a clear coat is put on top so the barcode isn't violated. If someone tampers with the clear coat or other aspects of the cover the cover will crumble apart. The cover and accompanying identifier can be stitched to garments in various discrete or not so discrete places depending on the preference of the manufacturer.

Additional embodiments may enhance the security aspects of the process and items when there is the ability to make the serial numbers or UID's of jeans or products encrypted so no one knows the actual UID.

Additional embodiments include BLE type information broadcasts, so there is no scanning needed. Thus the embodied applications detect and connect with UID and transfer information from one source (e.g., the identifier) to the other source (the application on the mobile device). Additional embodiments may include the ability of the user to have material from the application on the mobile device transferred onto the serial number or unique identifier. Additional embodiments include the ability of a user to broadcast information related to what they are wearing or using to peoples/friends mobile devices in the vicinity.

Another embodiment includes the ability to use NFC type identifiers such that when the identifier is tapped it will sent information to another identifier or a application in a mobile device. For example when a user has an NFC type identifier in their show they can tap the identifier and the identifier will send the user a message on a mobile device that the device would like to connect either with that device or another device or any other type message. Another embodiment includes the ability of two users each with NFC type identifiers in their shoes may both tap their shoes and both users would get a message on their mobile devices, such as a contact or a request, etc.,

Additionally, more embodiments include the ability to incorporate an accelerometer, 9-axis sensor, magnetometer, to measure movement and health. These capacities may be incorporated into different configurations of chips/modules. For instance if a shoe company wants to know how much a customer is walking in their shoe or how long a user is wearing it.

In smart phones and mobile devices that are equipped with RFID chips, the RFID detector is activated when the manager/administrator logs into the application using his or her username and password combination. The administrator can then enter the details regarding the RFID tags on a particular product that are automatically read and detected by the RFID detector in the iPhone, Android, Blackberry, or other smart phone. Smart phones are also equipped with Bluetooth connectivity, BLE capabilities, wifi, gps, and other connectivity sources for reading chips and or a combination of different technologies.

Similarly, smart phones equipped with NFC, RFID sensors can read and detect NFC, RFID tags on products. Once an OEM product is properly scanned, the verification of genuineness data is entered by the administrator into the manufacturer's or administrator's database along with other necessary product details.

According to an embodiment of the present disclosure, consumers can verify if an OEM product they are purchasing is genuine by using the customer module of the Synca™ APP installed in their iPhone, iPad, Android, Blackberry, or other smart phone. Using the camera, image sensor, RFID detector, or NFC sensor, or other communication or synchronization technology on the smart phone or mobile device, equipped with the Synca™ application, the customer can scan the bar code, QR code. RFID tag, or NFC tag on the product. The Synca™ APP compares the indicia, symbology, codes, or numbers against those in the manufacturer's database to find a match. Once the indicia, symbology, codes, or numbers have been compared, a message will appear on the iPhone, iPad, Android, Blackberry or other smart phone indicating if the product is genuine or not. If a product is a genuine OEM product, the message will read ORIGINAL, AUTHENTIC or GENUINE Product. If the Synca™ APP finds no match for the indicia, symbology, code, or numbers in the manufacturer's database, the message will read IMITATION or COUNTERFEIT Product.

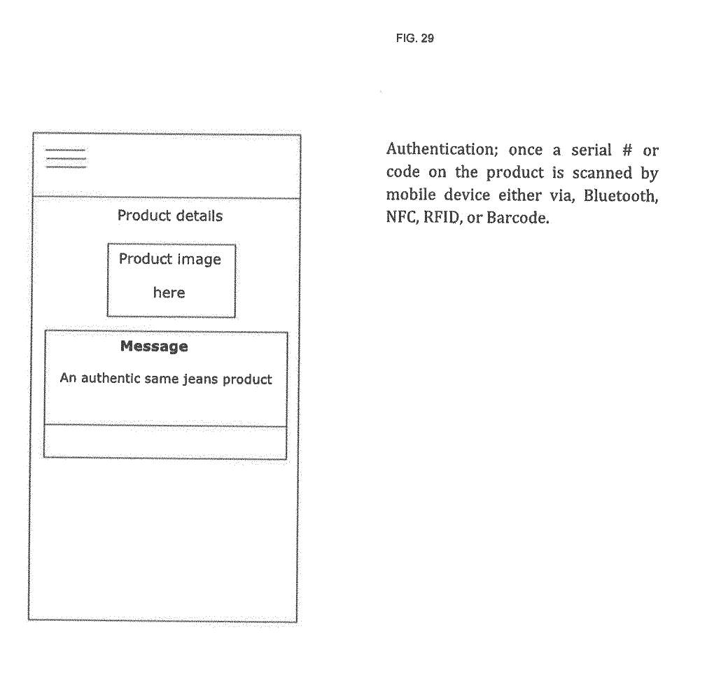

FIG. 29 illustrates a flow chart of the steps via which a consumer verifies the genuineness of a product and then, communicates with others on the manufacturer's social media websites, their own social media pages, and on SYNCA's virtual world or social page, on the Internet using the Synca™ APP. As shown in FIG. 29, the consumer can directly communicate with the manufacturer or the administrator by sending instant messages, and email with questions or comments, to which the manufacturer can respond in real time, thereby enhancing the consumer's shopping experience. As such, the mobile application (the Synca™ APP) builds a customized virtual world for manufacturer's and consumers to interact with each other. The flow chart in FIG. 29 also shows that the consumer can upload images of the product to various social media sites, where he or she can post comments and communicate with third or other parties about the product. As shown, the consumer can also access coupons and information about related products using a Synca application. The consumer may also have the ability to link to other consumers who have bought similar products or have similar buying habits. This is all done on the back end by SYNCA's software. For example, if a customer has a question regarding a particular watch, they can be linked to other customers who have also purchased similar items to make their experience more informed in terms of getting advice and or solutions to problems with the particular product.

After purchasing an OEM product which the consumer has verified as a genuine product, the consumer can register the product using functionalities of the mobile application (the Synca™ APP) on his iPhone, iPad, Android, Blackberry or other smart phone. The consumer can enter details about the product in the registration form on the Synca™ APP, specifying the owner's name company, address, contact phone number, contact e-mail address, serial number of the product, the store and location where the product was purchased, and whether the product is used or new, also the may upload receipts, images or invoice and or Warranty papers. The data of the purchase will be automatically generated by the Synca™ APP when the indicia, symbology, barcode, or QR code on the product is scanned with a smart phone camera or other image sensor, RFID detector. NFC sensor or other communication or synchronization technology.

Additional embodiments relate to the simplification of completing and storing registration for future use wherein the data of the purchase and the registration can be completed with the user information related to the embodied verification and authentication apps. The simplicity of this paperless registration process assists with company sustainability initiatives and makes the process much more complete with more accurate information versus unreliable information written in buy a consumer at a later time if ever.

Using an embodiment of the mobile application (the Synca™ APP), the manufacturer or administrator can generate and prepare reports regarding product and consumer base data, such as location, date of purchase, names of shops and businesses where a particular product is sold, whether any of them have been identified as selling an IMITATION or COUNTERFEIT product, as well as customer information to determine the demographics of existing and potential customers, thereby collecting relevant information for marketing and advertising purposes. For example, the manufacturer or administrator can generate graphs showing (1) product sales and dates of purchase; (2) product sales and location; (3) product sales in a particular location and the date of purchase; (4) product sales at a particular store or authorized retail establishment and the date of purchase; and (5) product sales in a particular store or authorized retail establishment and the specific type of OEM product. The manufacturers can gather data regarding retail term compliance. Additionally, the manufacturer may even provide a quick survey at the end asking the consumer why they chose X product over Y.

Another embodiment of the disclosure relates to the data analytic capabilities of quantitatively and qualitatively aggregating the data related to purchases, people demographics, buying habits, manufacturer's success related to pricing advertising, promotions and coupons and a variety of other general consumer and individual member based purchasing habits and decision making factors. The embodied synchronization application can determine buying and spending habits, preferences, size and shape of consumers and aggregate data from every scan. The data collected from each scan can be aggregated via proprietary software and the qualitative and/or quantitative data can be provided to manufacturers retailers, wholesalers, or distributors for better organizing their business and reacting quicker to the market and for synchronizing and streamlining all facets of the business. An example of a report that may be provided is shown in FIG. 7. Additional abilities include embodiments wherein the data collected can be further screened or secured both for data mining information when allowed or screed or secured from being shared in data mining operations.

After the customer module of the mobile application according to an embodiment of this invention (the Synca™ APP) has been installed in a smart phone or device, such as an iPhone, iPad, Android, or Blackberry personal digital assistant, and the consumer has used the application once to verify an OEM product, he or she does not have repeatedly enter in the username and password combination each time he or she operates the application. Rather, if the consumer opens the mobile application (the Synca™ APP) on his or her smart phone, Android, or Blackberry, and chooses the SCAN option in the application, the camera, image sensor, RFID detector, or NFC sensor on the phone, or other communication and synchronization technology automatically switches on, and scans, reads, or otherwise detects indicia, symbology, barcodes, QR codes, RFID tags, or NFC tags associated with particular OEM products. The indicia, symbology, barcodes, QR codes, RFID tags, and NFC tags, Bluetooth (BLE CHIPS), wifi, satellites, GPS, and or a combination of the listed items are compared against the information in the manufacturer's database using functionalities of the Synca™ application. If there is a match, a message appears on the consumer's iPhone, iPad, Android, Blackberry, or other smart phone, stating that the product is ORIGINAL or GENUINE Product. And, if there is no match, the mobile application program (the Synca™ APP) generates a message, stating that the product is an IMITATION or COUNTERFEIT Product.

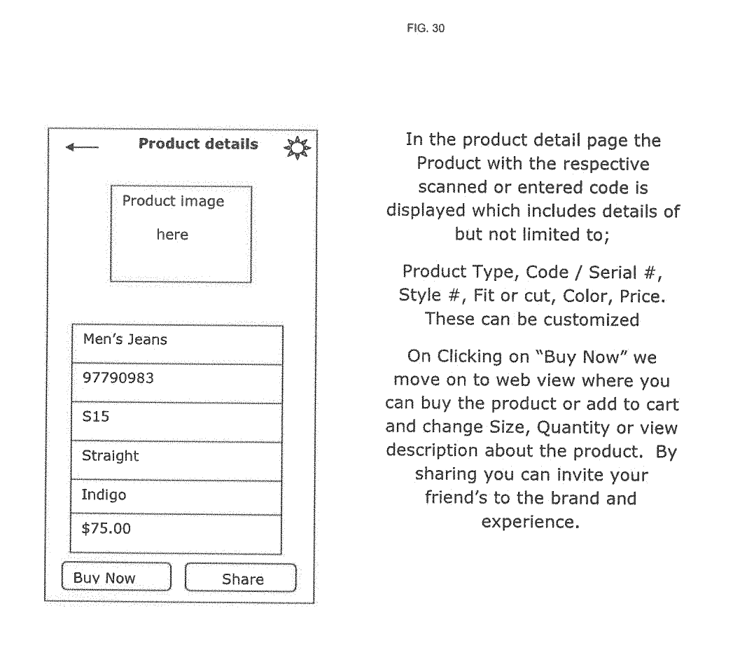

Consumers can also use the mobile application program (the Synca™ application) to retrieve other details about the product, which are stored in the database, such as product specifications, category, season of launch, VIDEOS, SOUND CLOUD, and the link to the manufacturer's, administrator's, SYNCA's or another companies, or the user's own social media or networking page, including Facebook, Twitter, Tumblr, Google+, blogs, official manufacturer website, and online shopping carts. With respect to the link to the manufacturer's Facebook page, the Synca™ APP would ask consumers with existing Facebook accounts to log into the site using their username and password information, and would ask those without Facebook accounts to sign up for a new account on Facebook. If the consumer has forgotten his or her Facebook password, functionalities on the mobile application (the Synca™ APP) linking to Facebook would allow the consumer to retrieve his or her password information. Once the consumer is at the manufacturer's Facebook site, he can enter comments about his or her experience with the OEM product, attach an image of the product from the manufacturer's library, or upload his or her own images and videos of the product, and then, select the button, PUBLISH STREAM. If successful, the message POSTED SUCCESSFULLY IN FACEBOOK appears on the consumer's iPhone, iPad, Android, Blackberry or other smart phone or device. FIG. 30 depicts the sequence of screens with prompts allowing the consumer to log into the manufacturer's Facebook page to post comments and share his or her experiences with the OEM product. The synchronized applications of the present disclosure also have the ability to link customers who have purchased similar products thus enhancing the social and consumer experience.

Using the mobile application according to an embodiment of this invention (the Synca™ APP), the consumer can also post comments, upload images of the product taken with the camera or imager or his or her iPhone, ipad, Android, Blackberry, or other smart phone or device, on his or her own Facebook page. The consumer can interact with other consumers who have posted comments about the OEM product using the functionalities available on Facebook, or other social networking site. The consumer may also post comments about products that were determined to be IMITATION Products by his or her Synca™ APP, thus alerting the manufacturer, and other existing and potential customers about knockoff and counterfeit products. Consumers may also post comments about where they purchased ORIGINAL Products, thereby, informing others about where such products are sold.

The mobile application according to an embodiment of this invention (the Synca™ APP) can also be used to post messages to other social media and networking sites, such as Twitter, Tumblr, and the manufacturer's and consumer's blogs. For example, with respect to a link to Twitter, the mobile application (the Synca™ APP) would request the consumer to enter username and password information if he or she is an existing user of Twitter. If the consumer is not an existing user of Twitter, he or she would be asked to create a new account in order to post tweets. As with Facebook, and other social media and networking pages, the consumer can retrieve a password if he or she has forgotten it. Once the consumer is logged in, he or she may type comments and select the button, PUBLISH. If successful, the message SUCCESSFULLY POSTED ON TWITTER is shown on the smart phone or device. The consumer can also see comments posted by other users about the OEM product. The consumer can follow the sequence of screens with prompts for entering log in information and comments on the manufacturer's Twitter website.

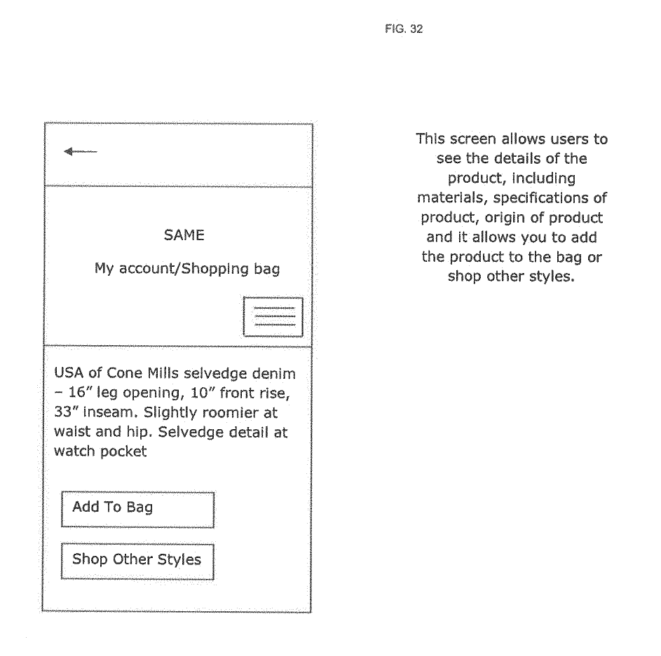

As described in the examples above, which are purely for illustration, and not limiting, the mobile application according to an embodiment of this invention (the Synca™ APP) enables consumers to communicate and exchange information about OEM products using social media and the Internet, while allowing manufacturer's a direct and immediate, reach to their existing and potential customer base. By using the mobile application according to an embodiment of this invention, (the Synca™ APP), manufacturers can quickly respond to the problem of counterfeiting, and further alert their customers of special events, sales, production issues, consumer claims, product defects, recalls, and other product related matters. The Synca™ APP enables direct contact between the consumers and manufacturers, allowing consumers to have an inside scoop about new merchandise while acting as brand ambassadors in sharing their personal experiences with certain products with people to whom they are connected in the virtual world, such as social media and networking sites. In this manner, the application enables users to promote OEM products by sharing their personal experiences with the products, and allows for instant brand interaction with consumers. A functional diagram which highlights the multiple interrelations of all the players associated with the synchronization of information is provided in FIG. 32. Additionally, consumers may be able to provide locations to manufacturers/police or other parties if they happen to come across fraudulent products, so the OEM or others can further investigate the matter.

An embodiment of the mobile application according to this invention (the Synca™ APP) enables OEM manufacturers to capitalize on the marketing capabilities of social media, where they can connect to their existing and potential consumer base, receive instant feedback, instant interaction about a particular product, such what consumers like and dislike about the product, while simultaneously allowing consumers a unique opportunity to directly interact with the OEM manufacturer and the product brand. For instance, the Synca™ APP can be used by manufacturers for promotional advertising and marketing purposes. As way of example, a manufacturer can introduce programs such as scavenger hunts, where consumers who scan the largest number of items using the Synca™ APP would qualify for a raffle prize or some other promotional item. In another program, after a consumer purchases an OEM product which is part of a particular promotion, and shares product information using the Synca™ APP, he or she will receive a coupon for a future purchase. Other marketing and advertising programs may be similarly rolled out using one or more embodiments of the mobile application according to this invention (the Synca™ APP). The consumer can also invite people from their network to the brand and forward them promotional and or events taking place via mobile, either via social media, text, or email.

Using another embodiment of the invention, consumers can interact directly with the OEM manufacturer, ability to chat with a person, gaining quick access to relevant product information. In yet another embodiment of the invention, they can also interact, connect, and invite with other consumers with similar tastes, styles, and interests, thereby sharing information, and benefiting from others' experiences with and reviews of a particular product they may be interested in acquiring. By way of example, as soon as a customer posts comments on a social media or networking page about his or her experience with a particular OEM product, people connected to that customer can see the information on the news feed or other updates provided by the social media or networking site. When consumers upload images of themselves using the product, or tag images available from the manufacturer's library on the Internet, others connected to those consumers can get access to the information via the social media and networking websites. Further, when a celebrity uses a product, scans it using the Synca™ APP, and posts images and comments regarding the product on the social media or networking site, such as Facebook or Google+, all those connected to or following the celebrity can access the information, thereby providing additional marketing and advertising opportunities to OEM manufacturers. An additional embodiment allows an embodied synchronization app to enable user's the option to link and sync to others with similar products, taste and or habits.

In a further embodiment, of the Synca™ APP, servers need not be used for any of the information and data exchange. Rather, all databases, interactions, and web traffic can be handled using online platforms. In yet another embodiment of the Synca™ APP, the manufacturer's or administrator's database may be available in a cloud instead of on a desktop computer and server.

It will be apparent to those skilled in the art that various modification and variations can be made in the method and system of the present invention without departing from the spirit or scope of the invention. Thus, it is intended that the present invention cover modifications and variations that come within the scope of the appended claims and their equivalents.

Although the invention has been described with reference to the above example, it will be understood that modifications and variations are encompassed within the spirit and scope of the invention. Accordingly, the invention is limited only by the following claims.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Review of various embodied features and capabilities of a synchronized application (herein “SYNCA”):

Embodied Synchronized applications allow the user to determine an authenticity of a product via mobile technology, utilizing either an Universal Product locator. Unique ID, barcode, NFC, RFID, and/or an image of the product or utilizing other communication or synchronization technology (which is compared to a database), along with other communication/synchronization technology.

Embodied Synchronized applications allow the manufacturer to know when a UPL is scanned at a retail location, where they can get real time data on the movement/sale of a product. The collection of data with every scan and performing data analytics and aggregating the data may be used to provide qualitative and quantitative data assessment information to retailers and manufacturers.

Embodied Synchronized applications allow the user to register the product via mobile after purchase.

Embodied Synchronized applications allow the user to scan a receipt or other documents needed, in order to send in for registration and or warranty or organize the user's purchase.

Once a user has a registration, it will be locked and only visible to the owner & law enforcement if lost or stolen.

Embodied Synchronized applications allow for the transfer of registration via mobile to a new party or owner.

When a product is scanned an embodied synchronized application allows the manufacturer to receive a log and notification of all products scanned with the location and user (optionally anonymized.

Embodied Synchronized applications allow the manufacturer to know if a user or customer is near their retail location, so they can send notifications or coupons to entice them to shop.

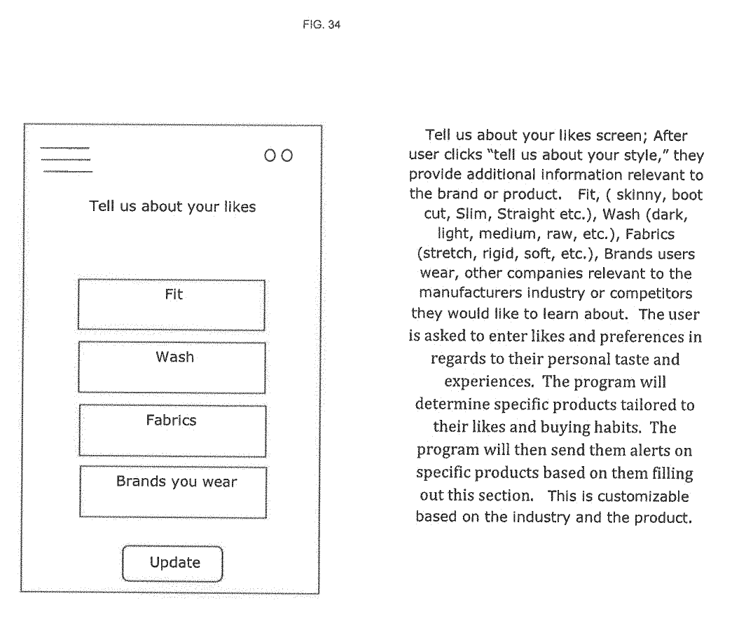

As shown in FIG. 34 Embodied Synchronized applications assist when a product is lost or stolen to get scanned by a finder the owner gets notified of the scan with location and user/finder along with law enforcement if applicable.

Embodied Synchronized applications allow a user to scan a code or product and enable the user to purchase that exact product instantly and other products via mobile.

Embodied Synchronized applications allow a user to scan a code or product and enable the user to save the products information and or image for later use or shopping.

Embodied Synchronized applications allow people to share their purchases and experiences on social media and also the application administrator's platform, where people share their thoughts, images and experiences about a product. This platform connects people who have a common interest in the same products, thus allowing the user to connect with people who may have the same interest.

Embodied Synchronized applications may contain an admin portal for the App, wherein manufacturers can update products and or codes, and run analytics on their mobile device or PC. This portal is accessed via mobile or web.

Additionally, embodied synchronized applications may provide a platform for Real time Analytics which can be run on mobile device or web which include what products are being sold or not sold, registered, on retail floor, where they are being scanned, how many are being scanned, who is buying them, who is scanning them. Real time Analytics can also determine the specific consumers buying habits and preferences. Embodied Synchronized applications may provide analytics based a consumers size, color preference, average dollar amount spending, where they are shopping, what they tend to buy, and how many people are in their network. This allows manufacturers/brands to send them target specific information.

Embodied Synchronized applications enable users to post on social media, either with comments and picture of the specific product already in Synca's or manufacturer's database or with their own picture they have uploaded via their device.

Embodied Synchronized applications enable customers and users to receive special notifications, recalls, coupons, points and messages that can be passed to their friends or in their networks.

Embodied Synchronized applications enable manufacturers to send a message to the customer after purchase to review their experience on the product. This message can be posted on social media upon the customer's approval.

Embodied Synchronized applications enable customers with same products to connect, upon approval of the party, which is being inquired, to get advise, or experiences with that specific product.

Embodied Synchronized applications enable customers to organize and manage their receipts, registrations, and purchases either via a Synca app or via a third party app such as passport. These receipts can be scanned or accepted via email or text notifications.

Synchronization of Stolen Item Information

Law Enforcement:

An embodied SYNCA APP maintains a way for law enforcement to utilize the app in addition to the consumer and manufacturer side.

If products are stolen or missing from manufacture, they may not want to designate them as ““stolen, or illicit” to the consumer scan, but we will designate them as “fake” or “compromised.” That way the consumer doesn't buy them and aid in the stolen merchandise black market. They will have the option to report the code and where it was scanned.

If products are missing or stolen, then the codes will be locked into a “stolen” or “compromised” position. So this way when it's scanned it will send a message to the manufacturer that the code was scanned at a particular location and the message “stolen or “compromised” will come up in the message instead of “fake” Only the message fake will come up to the consumer. A message can also be sent to law enforcement of the scan if the owner or the merchandise has reported it and is logged with law enforcement.

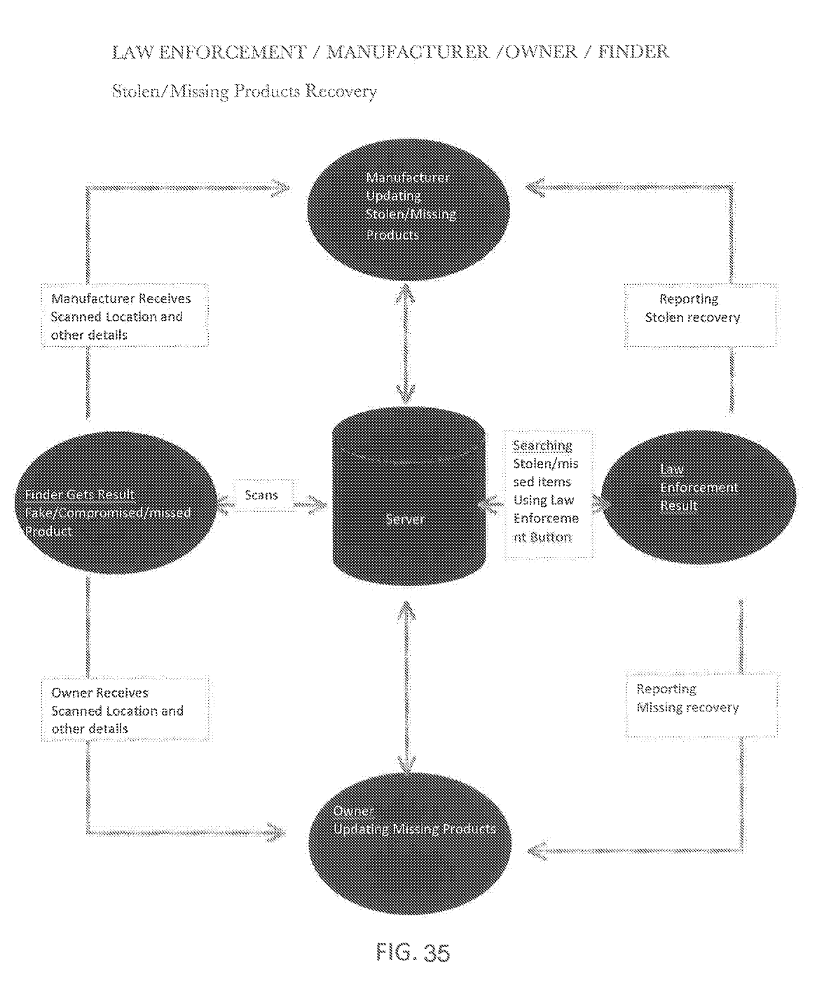

Law enforcement will have either a separate button only functioning for them, or a code they punch in to take them to a database where the stolen codes are stored. The scan will compare the codes and advise them if the product is stolen or compromised. They will be able to see if a police report or any other details is attached to these codes from the manufacturer to better identify the problem. When law enforcement scans, an option to whether or not the location will be sent to the manufacturer or the scan of the code is presented. A flow chart with showing the decision making interrelations is demonstrated in FIG. 35.

### Example 3

Synchronization Mobile Application is downloaded onto a mobile device.

The mobile device is used to scan a product of interest.

Information is synchronized with OEM site to confirm status of goods.

If product is authenticated a new set of optional after purchase decisions on the APP emerge.

Scan via barcode, QR, NFC, RFID via smartphone.

Message provided on phone whether product is real or fake.

After scan a message is simultaneously sent to manufacturer that the code and product has been scanned at a particular location. This feature is used by the app to determine if the product belongs to the retailer selling the goods, which eliminates copies of barcodes on counterfeit products. It also may eliminate the need for transshipping by retailers.

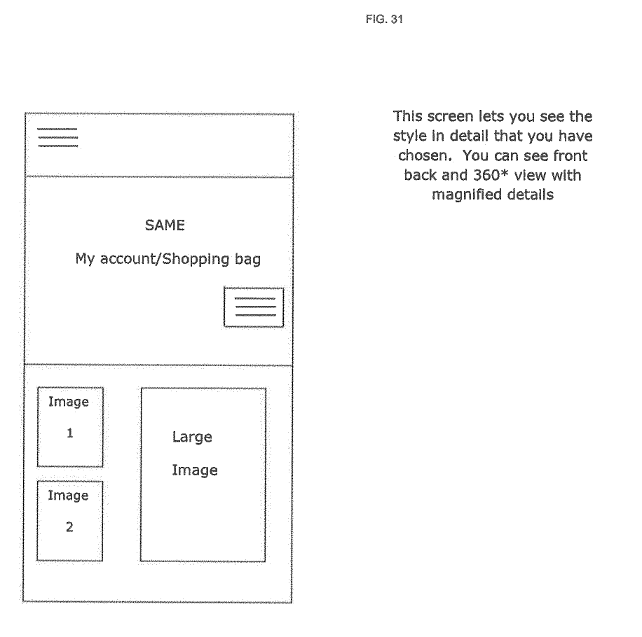

If product is counterfeit, then a message appears on the phone to the customer saying “this product is counterfeit, or fake.” An embodied depiction using the synchronized application is demonstrated in FIG. 31.

If the product is real the app will take the user into another screen advising the product is real or genuine (authentic), and will give the user the name of the product and style. There will be buttons you can choose from to continue your experience. A security feature contemplated may demand that in order for the user to continue they should be authorized to scan a receipt or put in their info.

The message displayed if product is legitimate could be “authentic” or “genuine” or other language pertaining to original or non-counterfeit goods.

If not real then the message displayed may be “fake” or “counterfeit” or other language pertaining to non-original or counterfeit goods.

If the product is stolen the “Stolen” or “Compromised” message is sent.

An additional gateway or doorway for law enforcement to check on goods in addition to the just normal app. One may not want normal consumers to see any Stolen goods on the app, only Law Enforcement.

For example if goods are stolen from a delivery, or inside the company. The company will take those set of codes and lock them into a “stolen or compromised” designation, so when it is scanned by law enforcement it will come “stolen or compromised” but on the consumer end it will come up “fake” so people are not tempted to buy “stolen” goods.

Example of an Embodied Mobile Synchronization Application

An embodied synchronization application is created to identify an OEM (original equipment manufacturer) product and a counterfeit product for consumers and manufacturers, while communicating on all Social Media platforms.

The embodied application aims to identify whether a product is genuine or imitation by BARCODE/QR/RFID/NFC comparison. The BARCODE/QR/RFID/NFC of the available products needs to be scanned and add relevant information such as where it made, which factory, which lot or cut #, what material lot was used from where, dye, bottles, fabric, metals, etc., where retailer has the product at, which operator or person worked on the product, etc., and selected information is saved by the manufacturer. When a consumer scans the BARCODE/QR/RFID/NFC of a product, a synchronization application (SYNCA) will take care of comparison with the manufacturer's scanned and added details. If the comparison matches then it will confirm it as a Genuine Product, otherwise will consider as an imitation product.

Buttons may be as follows: 1. Register 2. Re-scan 3. Buy 4. Product details 5. Comment 6. Store details 7. Coupon 8. Location 9. Facebook 10. Twitter 11. Pinterest 12. Promotions/coupons 13. Endorse 14. Report product 15. Website 16. Help 17. Link 18. Sync.

The user can post on social media about their product. They can post on the manufacturer's page as well as their own and share comments they may have.

The user can tag friends, and may receive a promotion or gift card that can be forwarded to their friends by sharing the coupons via the synchronization application. They can also invite friends to experience the brand, either through special promotions or events. These coupons, gift cards, promos, can be stored in passbook for later use.

The embodied Synca applications have a platform where all products scanned and commented will go to a site that is run by the application host. This platform is a space for all scanned products or products which have an image stored in the backend database to be instantly put on the application host's social media site. This site allows people to talk about their experiences and thoughts on companies after their purchases. It is sort of like “Angie's List” and Pinterest combined. It will “sync’ people who are talking about the same products. It will allow customers to post things from their other social media sights, so people can come to the application host site, to determine what is a good product and what may not be.

After a purchase the customer can register the product, in case it ever is lost or for any insurance purposes. A valid paperless registration process is provided and all is done via the Smartphone. This registration can be transferred to a new owner if applicable.

The user may have the option to buy the product instantly also. i.e., if you are in a coffee shop and admire someone's jacket. Instead of asking where they got the jacket, just simply scan the barcode. RFID, or NFC on the jacket, which will give information directing you to a buy button on the app. The user can even send a gift card to a colleague through the app if they happen to know he or she would like a particular product. Another embodiment enables the user to communicate and also send the manufacturer messages after scanning.

The customer also has the option to report the product to the manufacturer if the message appears “counterfeit”. They can add images and location be sent instantly when the code is scanned to the manufacturer.

While on comparison the manufacturer will receive a message which contains the scanned location of consumer and the consumer's information which collected on registration.

Once the comparison made by a consumer, it allows him/her to purchase the product online. Before purchase, the consumer can send the product link to multiple friends, option to the consumer to send a gift to a friend and post scanned information in all social media which configured on the device, with pie in database.

When a consumer scanned a product it automatically posts on SYNCA with an option message that will go on SYNCA's page or site by choosing an Icon of a heart or a check sign symbol, which endorses or says, “I vouch for this product” which let's the consumer know who synced, where and when. It works similar to Instagram with additional feature of texts entered by other consumers. Following are endorsements criteria, SYNCA adopted.

a) Heart=Love this

b) Check sign=vouch for

c) A person on a bicycle=You have to try this

SYNCA's Site page has similarities to popular site Pinterest but it is platform for people to talk about their experiences and loves of products or anything else they want to share with SYNCA and the public. If the consumer is posting on Facebook, it will also post on SYNCA's site. It has the option to share or sync multiple friends to the conversation about the product. The consumer also has the option to send a coupon or promotion to a friend via SYNCA. It Syncs the products together if multiple people are talking and syncing the same product and will let the consumer know this in real time. On this page SYNCA has incorporated with the following Buttons for ease of and communication:

a. Sync
b. Re-sync
c. Share
d. Buy
e. Love
f. Vouch
g. Try
h. Review
i. Tags

After purchasing the product, the customer can register the product and get a valid registration, which can be transferred upon the sale of the product by the owner. The owner locks information can save to passbook etc. I.e.—Rolex, Artwork, Paintings, or any high-ticket items.

The BARCODE/QR/RFID/NFC needs to be generated by the manufacturer or administrator or can be supplied by the owners of the synchronized technology, which will be available to them to maintain until the delivery made to a retailer or to a consumer. Each product BARCODE/QRIRFID/NFC will be unique which signifies either a product or SKU. No product should have the same digits, regardless of style/color/size/composition.

After purchasing the product, the customer can register the product and get a valid registration, which can be transferred upon the sale of the product by the owner. The owner locks information can save to passbook etc. I.e.—Rolex, Artwork, Paintings, or any high-ticket items

Scanning Methodologies

SYNCA equipped with the following scanning technologies:

a. Any Barcode or 2d Barcode

b. QR

c. RFID

d. NFC

e. Or other communication and synchronization technology

SYNCA APP available in following smart phones:

a. iPhone

b. Android

c. Blackberry

d. Windows

Following describes the working scenario of scanning BARCODE/QR

Open up the application installed in iPhone, Android or Blackberry phone and point camera to Barcode/QR

The camera detects the Barcode/QR.

It can also read NFC tags, which are read by NFC capable phones.

The RFID is scanned separately using the hardware in the phone.

This code is detected and sends information to the database.

The database is searched for the code and sends it back to the phone.

Modules

1. Customer Application

2. Manufacturer/Admin Application

Exemplary—Customer Application

1.1 The App Concept

Once the application is installed and logged in on any iPhone, Android or Blackberry type smartphone the phone does not need to re-login each time when the user starts the application.

Suppose a user goes to a store to buy a Nike limited edition shoe. The customer has doubt if the product is authentic or original or not.

The user opens up the SYNCA application installed in the phone.

The option in the application to SCAN is chosen. Additionally if the UID or Serial number include BLE or other broadcasting type capabilities then the embodied applications will automatically pick up the information on the mobile device. Thus, no scanning step may be necessary when the identifiers are equipped with broadcast capabilities.

The camera in the phone is switched “on” so the customer just has to shoot picture of the BARCODE/QR of article of interest (shoe in example).

The RFID is detected automatically by the application.

The NFC tag is read by the NFC phone using the SYNCA application.

The BARCODE/QR/RFID/NFC that is read is compared to the database.

If the item is found then the message is sent to the customer application that the product is authentic or genuine.

If the item is not found in the database then a message is generated saying imitation product.

After being scanned the application will upload the image to social media from a database as supplied by manufacturer's catalog or from the consumer's Instagram or camera.

The Consumer can message the manufacturer instantly for questions or comments, after or before the scan.

The application may also display similar products associated with the current products.

A Coupon Button for the providing for sending the coupon may be present.

The user may also use the application to find the details of any product with a Barcode/QR/NFID/NFC that is stored in the database.

Suppose the user sees a net book with a friend then the user can just scan the barcode/

QR/RFID/NFC to get all the details stored in the database.

This will provide the specification, name, category, Facebook and Twitter link depending on the entries in the database.

The Process

1.2 Login

Event—Enter the Username and Password and select “login” button.

Result—Successfully logged in if the login details are correct. Otherwise, it will show up in a pop up with a message “Username or Password Incorrect” and stays on the login screen.

1.3 Scanning the Product

Tapping “Scan” option of SYNCA application which activated the mobile camera and pointing to the Barcode/QR/RFID/NFC of the product.

1.4 Genuine Product will list out some of the following information after scanning:

Product name; where manufactured; which factory; which lot or cut #; what material lot was used; from where was it delivered; dye, bottles, fabric metals, etc.; where the retailer of the product is; which operator or person worked on the product, etc.; the manufacturer, displays “The Product is Original” message.

1.5 Imitation Product will list out some of the following information after scanning:

The manufacturer entered details are not available in the database for comparison; the mentioned retailer location is wrong; the product has already been owned by someone; the product is imitation or the product cannot be confirmed as authentic.

1.6 Automatically Sharing Consumer scanned information to manufacturer:

Where product has been scanned (using GPS or Manual entry); Name of the consumer who scanned it; Address; email address; telephone/mobile numbers.

1.7 Manually Sharing Product Information:

Sharing scanned product details with friends using SYNCA. Facebook, Twitter, Pinterest, Google+ and all other planned social medias; sending gift to friends; posting information to social media; manually sharing information about products to all friends and non-friends within different apps.

1.8 Virtual Communication possibilities:

Blog; Chat; Comments; Add ratings—Love this, I vouch for, you have to try this, etc.; similar kind of product listing; other products listed by the same manufacturer; sending queries or comments to the manufacturer.

1.9 Product Purchase—allows for online purchase of product.

1.10 Product registration:

Once the product is scanned and bought, the user can take ownership.

The registration may include the following Auto generated details, but the registrant can edit if necessary changes that need to be added or removed:

Company name; Date purchased; purchased from; owner name: address; country; contact phone; contact email; status-new/used; serial number.

1.11 Logout—the user selects a “log-out” button to log out or a time out button will automatically logout a user who has been inactive for a preselected period of time.

2. Manufacturer/Admin Application

The admin can ensure that the products they are selling are original by using a Synca application installed on a company smartphone.

The admin logs into the application using the username and password combination.

Once the admin is logged in he/she is able to scan any barcode/QR by the camera in the phone itself.

Clicking on the scan button will start the camera.

Just pointing the camera to the barcode/QR until it is read by the application correctly.

A RFID detector on the phone is activated when the user logs in to the application.

The detector automatically detects any RFID's and the admin enters the details.

The NFC tags can be read by the NFC phones.

Once the item is correctly scanned the data is stored into the database, along with the other necessary product details.

These details are entered by the manufacturer which is stored into the database, and can export the details, based on sales, demographics buying habits, style, color, region, season, scanned and un-scanned products.

The Process

2.1 Login

Event—Enter the Username and Password and select the “login” button. Result—the user is successfully logged in if the login details are entered correctly. Otherwise, it will show a pop up with a message “Username or Password Incorrect” and stay on the login screen.

2.2 Choosing Product

The available product types are listed on a drop down list. The user selects the product type of interest from the drop down list.

2.3 Scanning the Product of Interest.

Tapping “Scan” option of SYNCA application which activated the mobile camera and pointing to the Barcode/QR/RFID/NFC of the product.

The Product of interest will list out some of the following information after scanning:

Product name; where manufactured; which factory; which lot or cut #; what material lot was used; from where was it delivered; dye, bottles, fabric metals, etc.; where the retailer of the product is; which operator or person worked on the product, etc.; the manufacturer; displays “The Product is Original” message.

2.4 Sharing and Adding Coupons or Add-Ons:

The manufacturer may use the app to share coupons; share product to social networks; customer query answering area.

2.5 Logout—the user selects a “log-out” button to log out or a time out button will automatically logout a user who has been inactive for a preselected period of time.

An embodied synchronization application is created to identify an OEM (original equipment manufacturer) product and a counterfeit product for consumers and manufacturers, while communicating on all Social Media platforms.

3. Social Networking Features

3.1 Facebook

If an existing user, login with Facebook username and password. If a new user, sign up for Facebook then type the comments, attach the image from the library, or click on the button Publish Stream. Once the success message “Posted Successfully” in Facebook shows the information can get posted to Facebook and other social medias.

3.2 Twitter

If an existing user, login with Twitter username and password. If a new user, sign up for Twitter then type the comments, click on the “Publish” button. Once the success message “Posted Successfully” in Twitter shows the information can get posted to the Twitter.

4. Graphical Representations

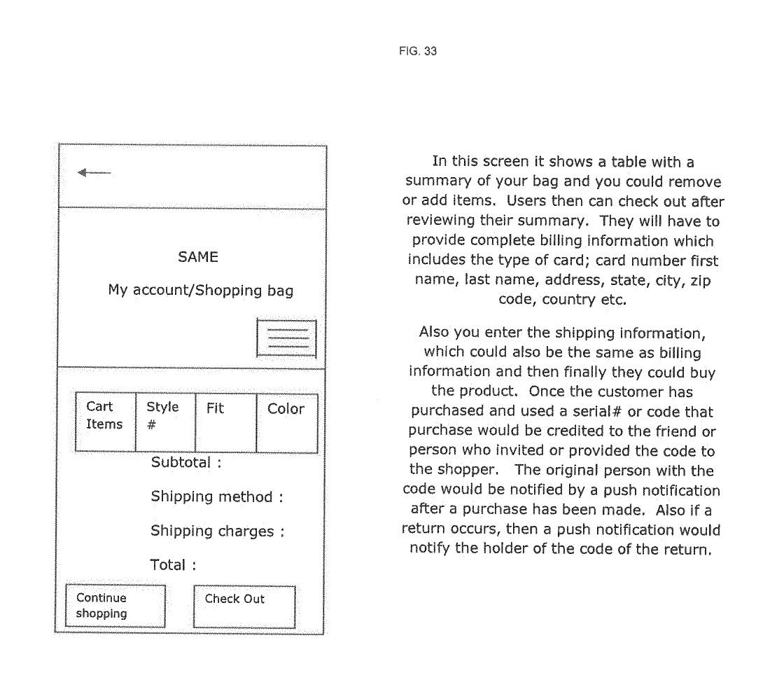

As represented in FIG. 33 which depicts exemplary graphing of embodied analytic reports via Sales and Scanning Analytics based on male/Female/Age using the Synca™ APP on a mobile device, once the product has been scanned and the product registration is done all the necessary details are stored into the database. Since data such as location, date of purchase, shop name etc., are stored, the corresponding data can be used for generating graphs. This in turn can be used for effective marketing.

The following are non-limiting examples of the types of graphs that can be generated:

Type 1—Graph with the product sales in a product with date (Daily, monthly yearly).

Type 2—Graph showing the product sales in a product with a location graph.

Type 3—Graph showing the product sales in a location with date.

Type 4—Graph showing the product sales in the store with date.

Type 5—Graph showing the product sales in a store with a product graph.

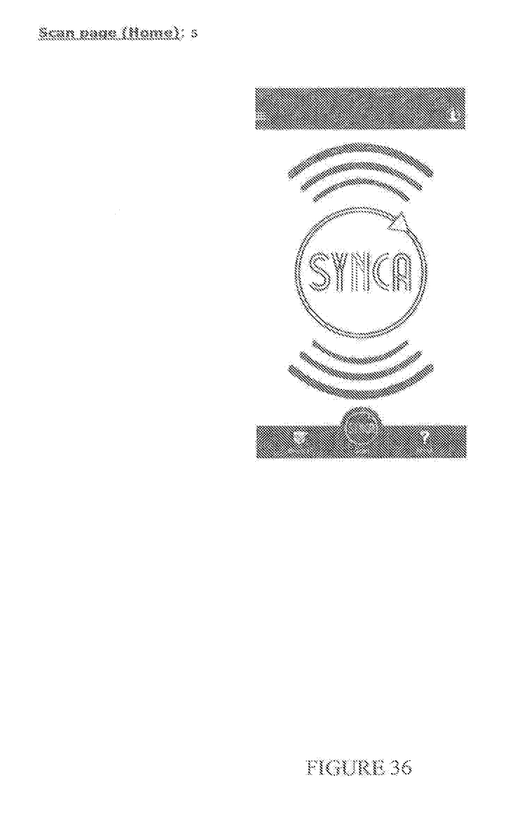

Additional Embodiments allow for the direct communication with Official Applications related to the Uniquely Identified Product. FIGS. 36-41 show exemplary screenshots of an application including a Synca™ APP could further include the ability to directly link with the Official Product Websites or Applications associated with an identified product. An example of this is shown in FIG. 36 including a screenshot of an embodied Synca™ APP including a multiples apps screen flow wherein the Scan Page or Home Page is shown. The Home page consists of three bottom tab bar buttons: 1) Brands, Companies or Products; 2) Synca scan; and 3) About. Pressing on ‘Brands’ button navigates to the page where it shows the list of brands. Scanning is done according to the device configuration. Scanning is done through any of the following modes: 1) BLE or Bluetooth; 2) NFC or RFID; and 3) Barcode code.

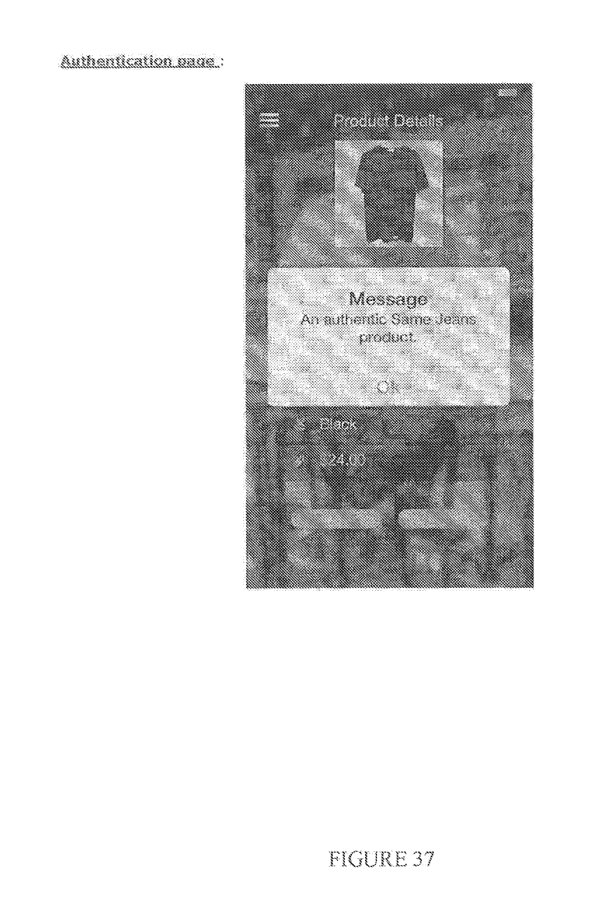

FIG. 37 shows what happens when a Same jeans type product is scanned with a unique identifier. FIG. 37 depicts a screenshot of an authentication page, which shows after an identified product (in this case a same jeans product is scanned). The pop up message alert is an authentication to confirm it is a Same Jean's product with a picture. The scan additionally opens up the correlating app within the Synca™ APP. In this case it is a Same Jeans App. The user can then instantly buy or share the product. Pressing on an OK button next navigates to the product's page. Similarly if a Pepe jeans product were to be scanned, it would show up in an authentication pop up message to confirm it is a Pepe jeans product, and open up the corporate or mobile app for Pepe jeans within the Synca™ APP. Additionally, if a Levi's Product was scanned, it also would show an authentication pop up message to confirm it is a Levi's Product and open up an Official Levi's Jeans app or website linked within the Synca™ APP.

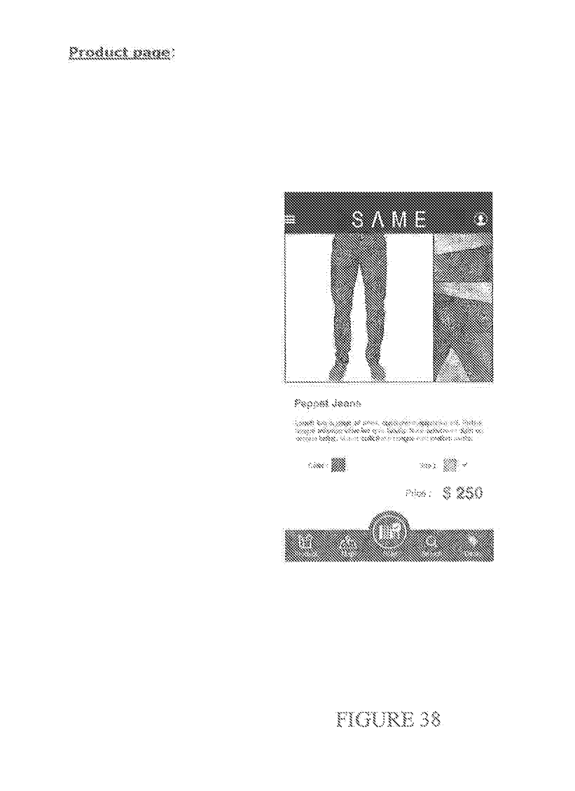

FIG. 38 depicts a screenshot showing how the link from the Synca site leads to the SAME Jeans website or mobile app. Upon pressing the OK button on the Same Jeans authentication pop up alert, the Synca app directs the user to the product page with the additional functionalities associated with the home website or mobile app for the Same Jeans product identified.

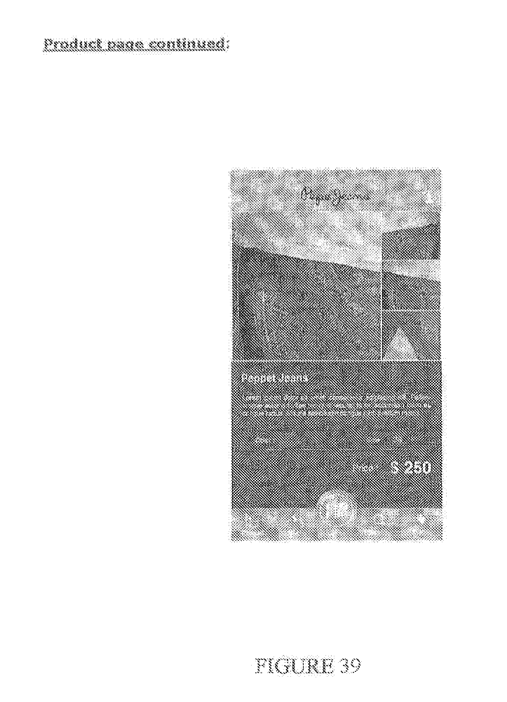

FIG. 39 depicts a screenshot showing how the link from the Synca site leads to the Pepe Jeans website or mobile app. Upon pressing the OK button on the Pepe Jeans authentication pop up alert, the Synca app directs the user to the product page with the additional functionalities associated with the home website or mobile app for the Pepe Jeans product identified.

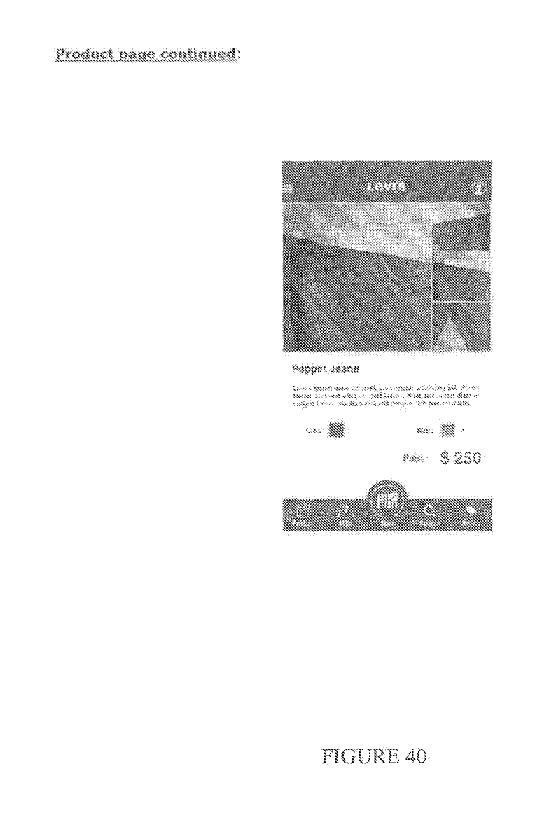

FIG. 40 depicts a screenshot of a final example showing how the link from the Synca site leads to the Levi's Jeans website or mobile app. Upon pressing the OK button on the Levi's Jeans authentication pop up alert, the Synca app directs the user to the product page with the additional functionalities associated with the home website or mobile app for the Levi's Jeans product identified.

Additionally, the bottom tab buttons for exemplary screenshots shown in FIG. 38-40 include: 1) Product—shows all products of the selected brand: 2) Map—shows all the stores under the selected brand in a locality on a map, and also people wearing the same product as the user scanned or was browsing; 3) Scan—Navigates to the home page where the user can again scan another product: 4) Search—User can search for a product; and 5) Deals—Shows all the discounts and offers available for the selected brand.

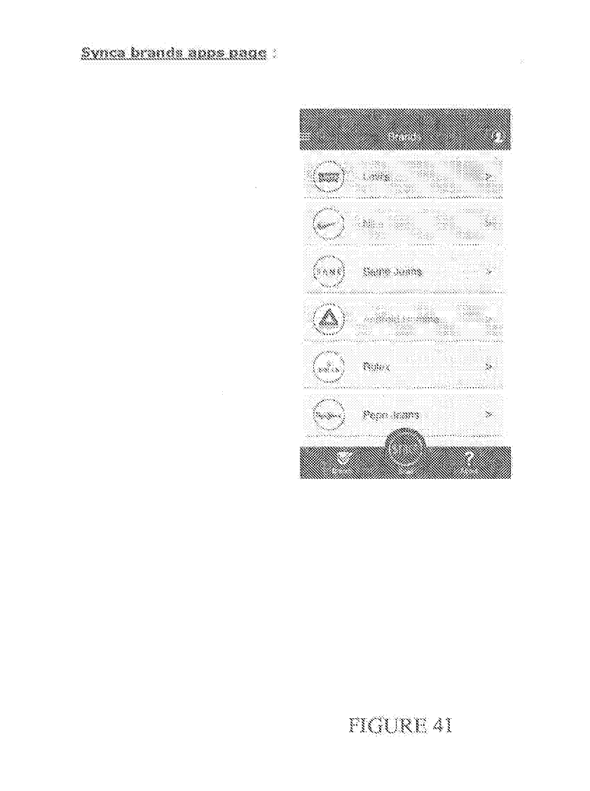

FIG. 41 depicts a screenshot of an exemplary embodied Synca brands apps page which shows a list of exemplary brands within listed within an exemplary Synca type app. It may be in a list view or a tile view. Upon clicking on each product, the user is redirected to the app or website associated with that particular brand. The user also has the option to scroll to the brand or app they wish to use. For example, if the user sees a Nike shoe on a friend and wants to scan it, they can scroll to the Nike App linked through the Synca App and can scan it to get more information or to buy.

Although the invention has been described with reference to the above example, it will be understood that modification and variation are encompassed within the spirit and scope of the invention. Accordingly, the invention is limited only by the following claims:

1-20. (canceled)

21. A product comprising:
an original equipment manufacturers (OEM) manufacture product or a component of a product,
a unique identifier, wherein said unique identifier comprises one or more readable or transmittable codes that may be read by a mobile device or computer with the software or mobile device application wherein said readable or transmittable codes are selected from the group consisting of Bluetooth, Bluetooth low energy (BLE), and RFID, GPS, Wi-Fi, 9-Axis sensor, and barcode,
a housing wherein said unique identifier is contained and enclosed within said housing, and wherein said housing is water-proof,
wherein the one or more readable or transmittable codes provide a link to information relating to the product or a component of a product.

22. The product of claim 21, wherein the product is selected from the group consisting of clothing, shoes, luggage, handbags, and toys, and wherein the housing and unique identifier is contained and enclosed within and is secured to the product in or adjacent to the seams.

23. The product of claim 22, wherein the housing and unique identifier contained and enclosed within is positioned on the interior of the product such that the housing and unique identifier is contained and enclosed within is not visible when viewing the exterior of the product.

24. The product of claim 21, wherein the information relating to the product or a component includes a direct link to a website, e-commerce site, customer service site, or other mobile device applications associated with the identified good.

25. The product of claim 21, wherein the information relating to the product or a component includes links into an official company mobile application for the product identified.

26. The product of claim 21, wherein the housing is suitable for preventing the unique identifier contained and enclosed within from being damaged when being worn and/or laundered.

27. The product of claim 21, wherein the housing and unique identifier contained and enclosed within are permanently affixed onto a product such that the removal and replacement is obvious of product tampering.

28. The product of claim 27, wherein upon product tampering an auto notification is sent to a manufacturer that the unique identifier has been removed or tampered with.

29. The product of claim 21, additionally comprising LED lights.
